(19) United States
(12) Patent Application Publication
(10) Pub. No.: US 2025/0296858 A1
(43) Pub. Date: Sep. 25, 2025

(54) HVAC ANTI-BIOGROWTH AND ALERT DEVICE

(71) Applicant: INOVOTRON, LLC, Plymouth, MN (US)

(72) Inventors: Louis Ciro COSENTINO, Palm Beach Gardens, FL (US); Daniel L. COSENTINO, Wayzata, MN (US); Brian Alan GOLDEN, Eden Prairie, MN (US)

(21) Appl. No.: 19/085,895

(22) Filed: Mar. 20, 2025

Related U.S. Application Data
(60) Provisional application No. 63/568,075, filed on Mar. 21, 2024.
(60) Provisional application No. 63/759,408, filed on Feb. 17, 2025.

(51) Int. Cl. C02F 1/461; C02F 1/46

(52) U.S. Cl. CPC C02F 1/46109; C02F 1/4606; C02F 2001/46152; C02F 2201/46135; C02F 2201/4614; C02F 2303/04

(57) ABSTRACT

The present disclosure relates to biocide-generating devices that are compatible with a variety of different condensate tray configurations and/or drain configurations and that are configured effectively generate biocide in gravity drained condensate trays and/or their corresponding drains.

### CROSS-REFERENCE TO RELATED APPLICATION

The present application claims the benefit of U.S. Provisional Patent Application No. 63/568,075, filed Mar. 21, 2024, and U.S. Provisional Patent Application No. 63/759,408, filed Feb. 17, 2025, the disclosures of which are hereby incorporated by reference herein in their entirety.

### BACKGROUND

Heating, ventilation, and air conditioning (HVAC) systems typically include air treatment components that treat air within an air plenum and that collect and manage water from condensation. In practice, an air treatment component can include an evaporator coil over which warm air is passed causing cooling of the air and concurrently causing the formation of condensation on the evaporator coil. A condensate tray is positioned below the evaporator coil for collecting condensation that falls (e.g., drips, drops, etc.) by gravity from the evaporator coil. The condensate tray includes a drain port for draining the collected water from the condensate tray to prevent the collected water from overflowing the condensate tray. The drain port drains water via gravity out of the air plenum of the HVAC system and is part of a drain line that carries the drained water via gravity to an outside environment or to a drain of a building plumbing system.

Water collected within a condensate tray can support a proliferation of biological organisms and, over time, biological growth and buildup can occur in the condensate tray itself, at the drain port or in the drain line. Examples of organisms that commonly grow include mold and other fungi, such as aspergillus. The buildup of biological growth can eventually cause a blockage or partial blockage that interferes with the effective draining of water from the condensate tray which can lead to overflowing of water from the condensate tray and flooding. Flooding can damage the air treatment component itself, as well as the structure housing the unit, e.g., a home or other building.

A condensate tray is often integrated as part of an evaporator unit containing an evaporator (e.g., an evaporator coil). The evaporator unit includes a housing configured to be incorporated within a duct system defining an air plenum. Condensate trays can have different configurations often dependent upon the configuration of the evaporator and/or the way air flow is routed through the evaporator unit. FIG. 1 depicts an example pan style condensate tray 10a positioned below an evaporator 12a of an evaporator unit 14a configured such that air flow through the evaporator unit 14a is directed laterally through the evaporator 12a above the condensate tray 10a. A drain 13a allows water to exit the condensate tray 10a by gravity. FIG. 2 depicts an example outer frame style condensate tray 10b positioned below an evaporator 12b of an evaporator unit 14b configured such that air flow through the evaporator unit 14b is directed upwardly through the condensate tray 10b and upwardly through the evaporator 12b above the condensate tray 10b. The condensate tray 10b includes a trough/channel that defines a rectangular frame positioned below a lower perimeter of the evaporator 12b. The condensate tray 10b includes a gravity feed drain 13b. The trough/channel surrounds a central opening through which air flows upwardly to enter the evaporator unit 14b and flow upwardly through the evaporator 12b. FIG. 3 depicts an example center channel style condensate tray 10c positioned below an evaporator 12c of an evaporator unit 14c configured such that air flow through the evaporator unit 14b can be directed upwardly or horizontally through the evaporator 12c above the condensate tray 10c. The condensate tray 10c includes a central trough/channel positioned below a lower central region of the evaporator 12b and includes a gravity feed drain 13c.

There is a need for improvements in systems and methods for reducing biological growth and buildup in condensate pans, drain lines, and associated components of air treatment systems.

### SUMMARY

Aspects of the present disclosure relate to biocide-generating devices that are compatible with a variety of different condensate tray configurations. In certain examples, the biocide-generating devices can each include an electrode arrangement adapted to generate biocide adjacent a drain (e.g., a gravity feed drain) of a condensate tray to prevent bio-growth adjacent a drain port of the condensate tray and/or within a drain line extending from the condensate tray. In certain examples, the electrode arrangement is adapted to be supported at a bottom of the condensate tray and is configured for allowing condensate water to flow under and/or through the electrode arrangement. In certain examples, the electrode arrangement is configured to minimize or eliminate damming or blocking of water within the condensate tray. Aspects of the present disclosure also relate to electrode arrangements that can be incorporated in drain lines (e.g., drain plumbing) corresponding to condensate trays. Aspects of the present disclosure also relate to electrode arrangements that can be incorporated in drain lines of other types of water collection vessels which in certain examples are gravity drained. Aspects of the present disclosure also relate to electrode arrangements that can be incorporated in flow-through housings (e.g., enclosures, containers, canisters, etc.) adapted to be incorporated as part of drain lines such as gravity feed drain lines for draining liquid such as water from vessels such as water collection vessels.

The details of one or more embodiments are set forth in the accompanying drawings and the description below. Other features, objects, and advantages of these embodiments will be apparent from the description, drawings, and claims. Moreover, it is to be understood that both the foregoing summary of the disclosure and the following detailed description are exemplary and intended to provide further explanation without limiting the scope of the disclosure.

### DESCRIPTION OF THE DRAWINGS

The following figures, which form a part of this application, are illustrative of described technology and are not meant to limit the scope of the disclosure.

FIG. 1 depicts a prior art evaporator unit including a pan-style condensate tray;

FIG. 2 depicts a prior art evaporator unit including a frame-style condensate tray;

FIG. 3 depicts a prior art evaporator unit including a center-channel-style condensate tray;

FIG. 4 is a perspective view of a biocide-generating electrode arrangement in accordance with the principles of the present disclosure;

FIG. 5 is a top view of the electrode arrangement of FIG. 4;

FIG. 6 is a bottom view of the electrode arrangement of FIG. 4;

FIG. 7 is a front view of the electrode arrangement of FIG. 4;

FIG. 8 is an end view of the electrode arrangement of FIG. 4;

FIG. 9 is an opposite end view of the electrode arrangement of FIG. 4;

FIG. 10 is a cross-sectional view taken along section line 10-10 of FIG. 5;

FIG. 11 is a cross-sectional view taken along section line C-C of FIG. 5;

FIG. 12 is a top, front perspective view of another biocide-generating electrode arrangement in accordance with the principles of the present disclosure;

FIG. 13 is a bottom, front perspective view of the biocide-generating electrode arrangement of FIG. 12;

FIG. 14 is a bottom view of the biocide-generating electrode arrangement of FIG. 12;

FIG. 15 is front is a side view of the electrode arrangement of FIG. 12;

FIG. 16 is a transverse cross-sectional view of the electrode arrangement of FIG. 12;

FIG. 17 is the transverse cross-sectional view of FIG. 16 showing the angles of exposed surfaces of the electrodes;

FIG. 18 is the transverse cross-sectional view of FIG. 16 showing coverage angles provided by the support structure;

FIG. 19 is a top, front perspective view of further biocide-generating electrode arrangement in accordance with the principles of the present disclosure;

FIG. 20 is a bottom, front perspective view of the biocide-generating electrode arrangement of FIG. 19;

FIG. 21 is a top view of the biocide-generating electrode arrangement of FIG. 19;

FIG. 22 is a bottom view of the biocide-generating electrode arrangement of FIG. 19;

FIG. 23 is a front side view of the electrode arrangement of FIG. 19;

FIG. 24 is an end view of the electrode arrangement of FIG. 19;

FIG. 25 is a schematic view of an evaporator unit including an electrolytic biocide generating system in accordance with the principles of the present disclosure for generating biocide used to prevent plugging/drain blockage of a collection tray of the evaporator unit;

FIG. 26 depicts the electrolytic biocide generating system of FIG. 25 modified to include an additional biocide-generating electrode arrangement positioned in the drain of the collection tray;

FIG. 27 is a schematic view of a controller of the biocide generating system of FIG. 25;

FIG. 28 depicts a portion of a water collection system including an electrolytic biocide generating system in accordance with the principles of the present disclosure; the electrolytic biocide generating system includes a flow-through housing containing a biocide-generating electrode arrangement which is shown connected in-line with a gravity drain of the water collection system;

FIG. 29 depicts a portion of a water collection system including another electrolytic biocide generating system in accordance with the principles of the present disclosure; the electrolytic biocide generating system includes an alternative flow-through housing containing a biocide-generating electrode arrangement which is shown connected in-line with a gravity drain of the water collection system;

FIG. 30 is a cross-sectional view taken through the flow-through housing of FIG. 29 along section line 30-30; and

FIG. 31 depicts another electrode configuration in accordance with the principles of the present disclosure for use in a drain line;

FIG. 32 depicts a further electrode configuration in accordance with the principles of the present disclosure for use in a drain line.

FIG. 33 is a perspective view of another electrode device in accordance with the principles of the present disclosure;

FIG. 34 is a side view of the electrode device of FIG. 33;

FIG. 35 is an enlarged perspective view of an electrode arrangement of the electrode device of FIG. 33;

FIG. 36 is another enlarged perspective view of the electrode arrangement of FIG. 35;

FIG. 37 is a cross-sectional view taken along section line 37-37 of FIG. 34;

FIG. 38 is a cross-sectional view taken along section line 38-38 of FIG. 34;

FIG. 39 is a cross-sectional view taken along section line 39-39 of FIG. 34;

FIG. 40 is a cross-sectional view taken along section line 40-40 of FIG. 34; and

FIG. 41 is an electrical connector of the electrode device of FIG. 33.

### DETAILED DESCRIPTION

Various embodiments of the present inventions will be described in detail with reference to the drawings, wherein like reference numerals represent like parts and assemblies throughout the several views. Reference to various embodiments does not limit the scope of the inventions. Additionally, any examples set forth in this specification are not intended to be limiting and merely set forth some of the many possible embodiments for inventive aspects in accordance with the principles of the present disclosure.

Aspects of the present disclosure relate to systems for effectively inhibiting bio growth in water drain systems such as drain lines and water collection vessels such as condensate trays. The condensate trays can be positioned beneath evaporator coils and can be configured to receive condensate that falls from the evaporator coils. The evaporator coils and condensate trays can be installed within a housing adapted to be connected to a duct system defining an air plenum such that air in the plenum moves through the housing and across/through the evaporator coils. The condensate trays can have drain ports for draining water from the condensate trays away from the air plenum by gravity. In certain examples, a drain port can be defined through the bottom or through a side wall of a condensate tray. In certain examples, the drain ports are part of drain lines for draining water by gravity to an outside location or to a plumbing system of a building. It will be appreciated that typical condensate trays are designed such that water continuously drains from the condensate trays when the trays are operating properly with the result being that the water depth within the trays is relatively small (e.g., relatively thin sheets/films of water that flow within the condensate trays toward the drains). Drain lines can include structures such as drain ports, hoses, pipes, tubing, fittings, couplers, in-line housings and other structures that can cooperate to define a flow path (e.g., a flow path/passage with flow driven be gravity) for conveying fluid such as water.

Aspects of the present disclosure relate to an electrode device designed to effectively generate biocide in flowing water having a relatively small depth.

Aspects of the present disclosure also relate to electrode devices (e.g., electrode arrangements including at least one bio-inhibiting electrode) configured to effectively treat condensate water (e.g., release biocide into the condensate water) while concurrently being configured to minimize or eliminate water flow blockage (e.g., damming).

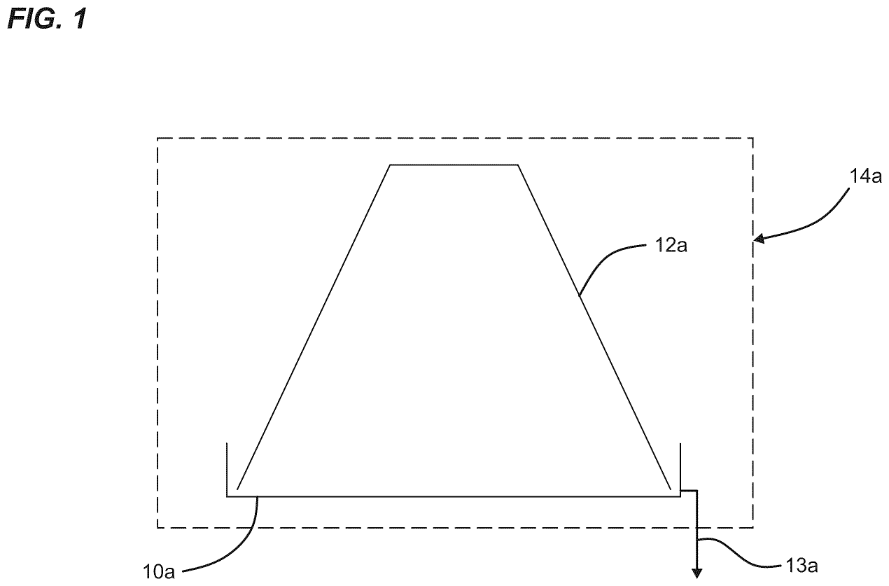

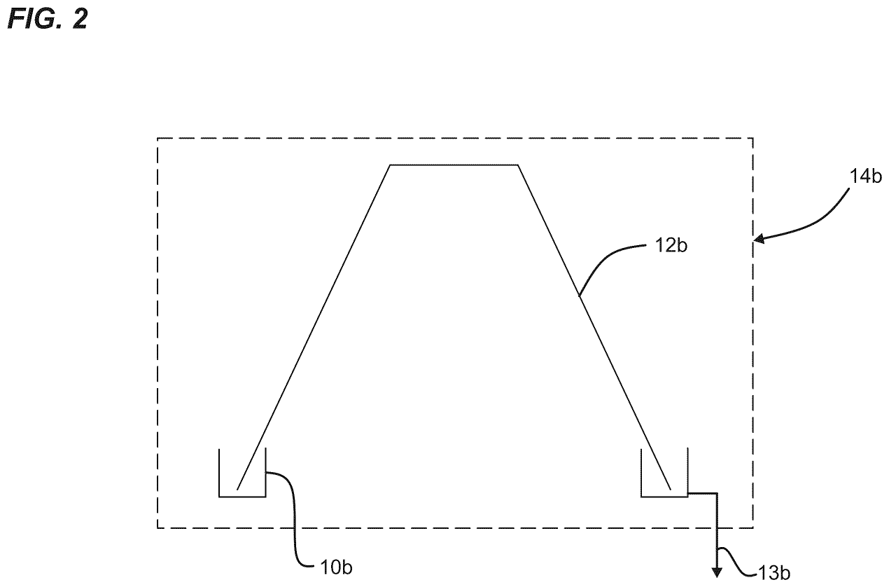

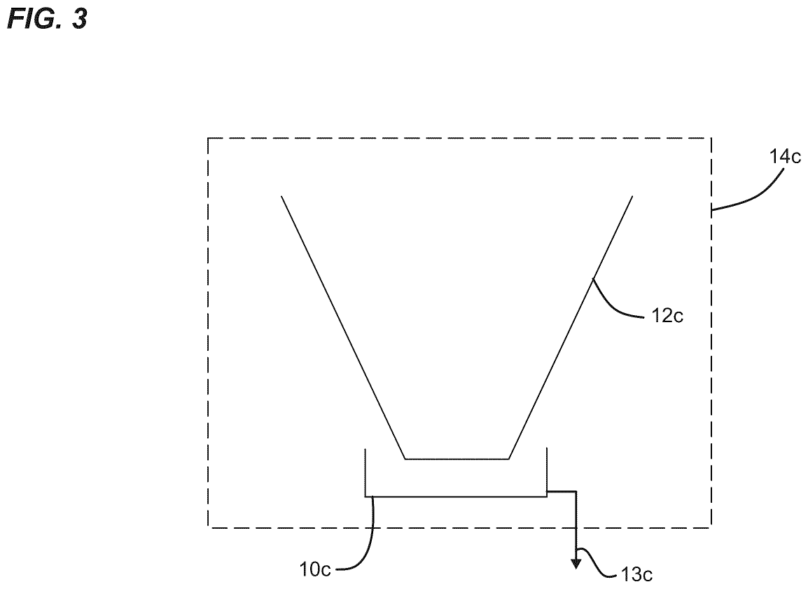

Aspects of the present disclosure also relate to electrode devices (e.g., electrode arrangements including at least one bio-inhibiting electrode) that are compatible with a variety of different condensate tray designs such as the different tray designs depicted at FIGS. 1-3. Aspects of the present disclosure relate to electrode devices configured to be mounted within condensate trays (e.g., at bottoms of the condensate trays). Aspects of the present disclosure also relate to electrode devices configured to be incorporated in condensate drain lines (e.g., gravity feed drain lines) for treating water (e.g., condensate water) flowing through the drain lines (e.g., via gravity). In certain examples, the electrode devices can be mounted partially or fully directly in the drain lines. In some examples, the drain lines being treated by the electrode devices can have an inner cross-dimension (e.g., an inner diameter) less than or equal to 1.5 inches or less than or equal to 1 inch or less than or equal to 0.75 inches.

Aspects of the present disclosure also relate to an electrode device (e.g., an electrode arrangement including at least one bio-inhibiting electrode) configured to effectively treat condensate water (e.g., release biocide into the condensate water) in a tray or other structure and which is configured such that the electrodes contact a bottom of the tray or other structure when the electrode device is installed in the tray or other structure. In one example, the electrodes have lengths that are vertically arranged with distal ends being positioned to contact the bottom of the tray or other structure when the electrode device is installed. In one example, the other structure can include a component of a drain line (e.g., a drain tube, a hose, a pipe, a flow-through housing, a fitting, a hose/pipe/tube coupler, a drain port, etc.).

Aspects of the present disclosure also relate to an electrode device (e.g., an electrode arrangement including a bio-inhibiting electrode and a non-bio-inhibiting electrode) configured to effectively treat condensate water (e.g., release biocide into the condensate water) and in which an exposed water contact surface of the bio-inhibiting electrode is larger than an exposed water contact surface of the non-bio-inhibiting electrode. In certain examples, the area of the exposed water contact surface of the bio-inhibiting electrode is at least 2, 3 or 4 times as large as the area of the exposed water contact surface of the non-bio-inhibiting electrode. In one example, the bio-inhibiting electrode includes a rectangular bar and the non-bio-inhibiting electrode includes a cylindrical rod. In one example, the exposed water contact surface of the bio-inhibiting electrode is planar and the exposed water contact surface of the non-bio-inhibiting electrode is curved.

Aspects of the present disclosure also relate to an electrode device for generating biocide in water within a condensate tray or other structure (e.g., a component of a drain line). The electrode device includes an electrode support structure defining a base reference plane that coincides with a bottom of the condensate tray or other structure when the electrode device is supported within the tray or other structure. The electrode device also includes first and second electrodes supported above the base reference plane by the electrode support structure. The first and second electrodes have lengths that extend along the base reference plane. The first electrode is a bio-inhibiting conductor and includes a water contact surface that extends along the length, that is exposed and that faces toward the base plane.

Aspects of the present disclosure also relate to an electrode device for generating biocide in condensate water that includes a support structure and first and second electrodes retained in spaced apart relation relative to each other by the support structure. At least the first electrode is a bio-inhibiting conductor. The support structure and/or the electrodes include a base structure configured to contact a bottom of a condensate tray or other structure when the electrode device is installed within the condensate tray or other structure. The support structure and/or the first and second electrodes define an open region for allowing water flowing along the bottom of the tray or other structure to flow under and/or through the electrode device to prevent damming of the water. The minimization of water flow blockage makes the electrode device more compatible with a variety of different condensate trays, particularly those having narrower collection channels and also makes the electrode device compatible with mounting in other structures such as components of drain lines. In certain examples, the electrode device can be manufactured in small sizes compatible with mounting in condensate drain lines.

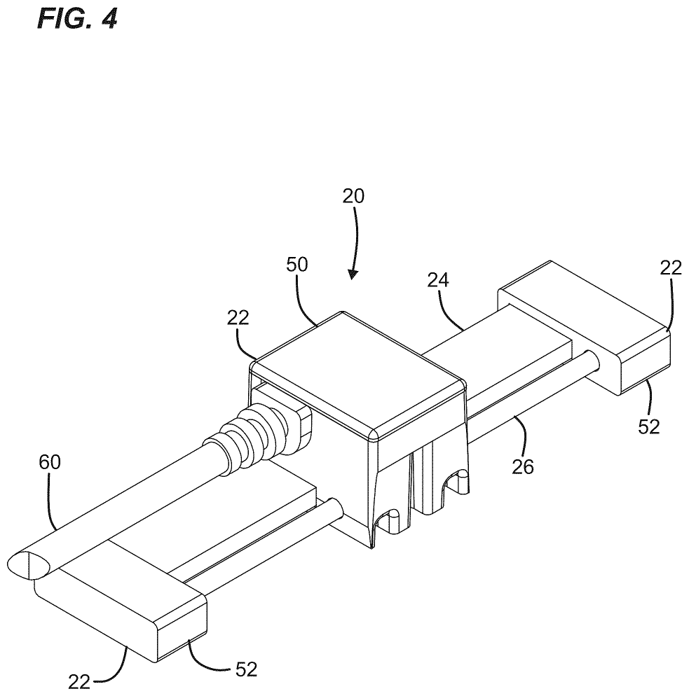

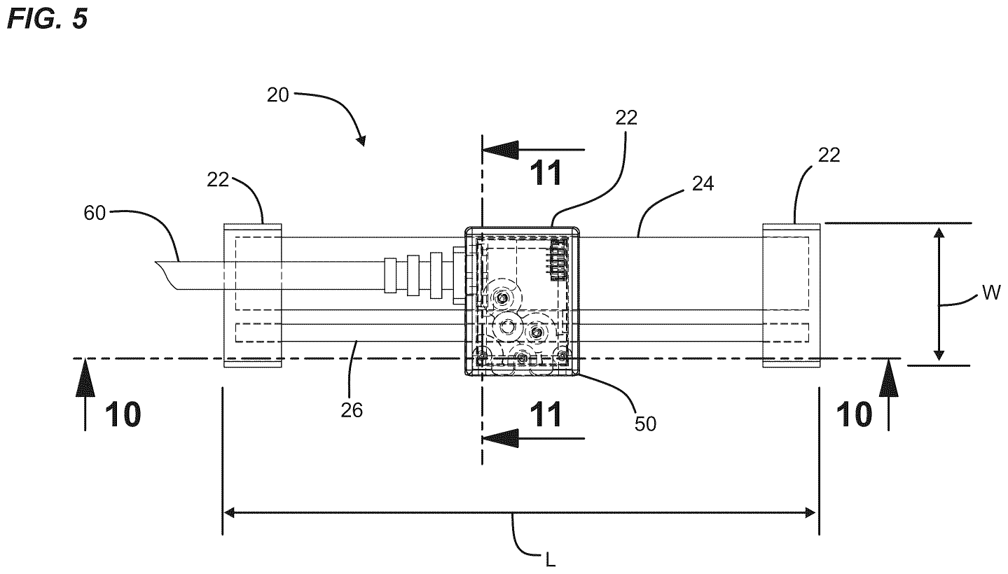

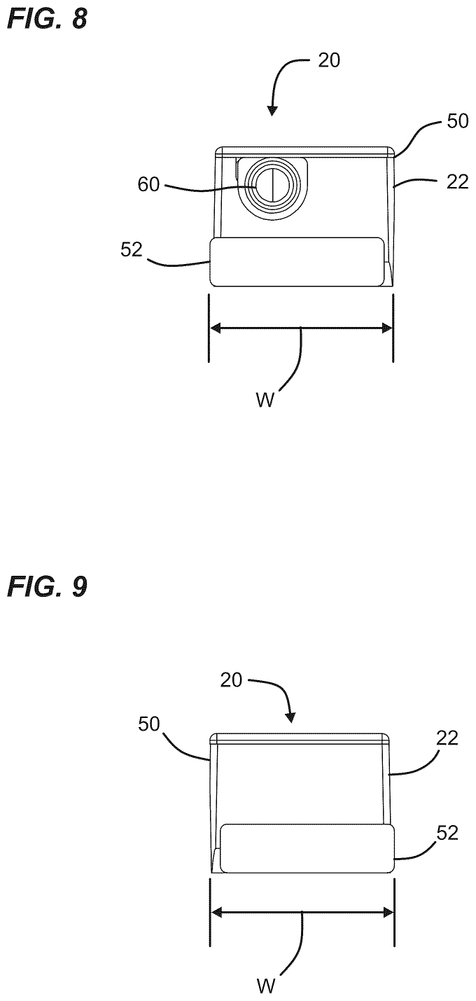

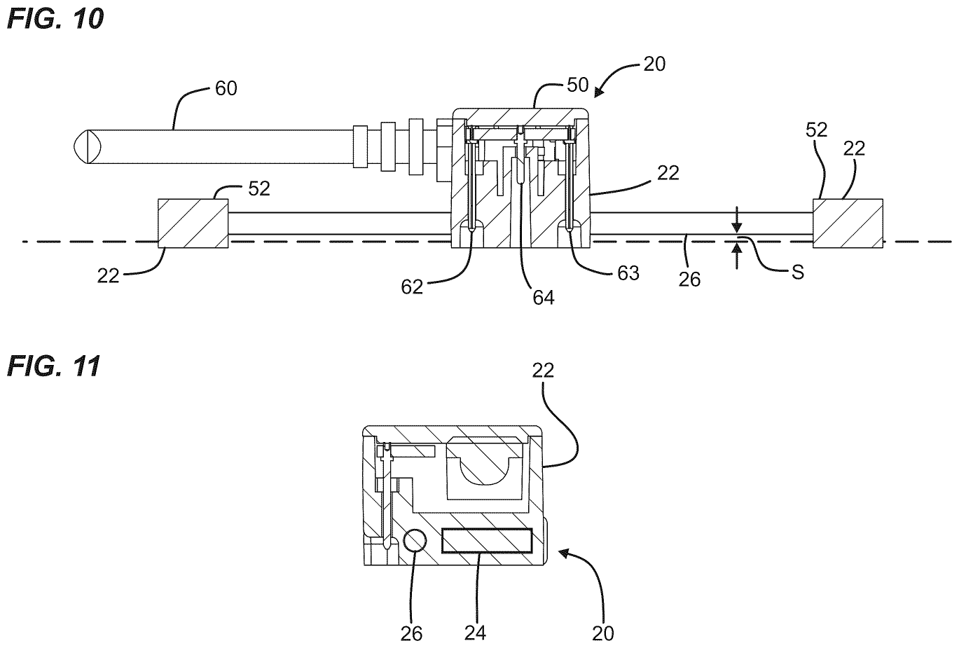

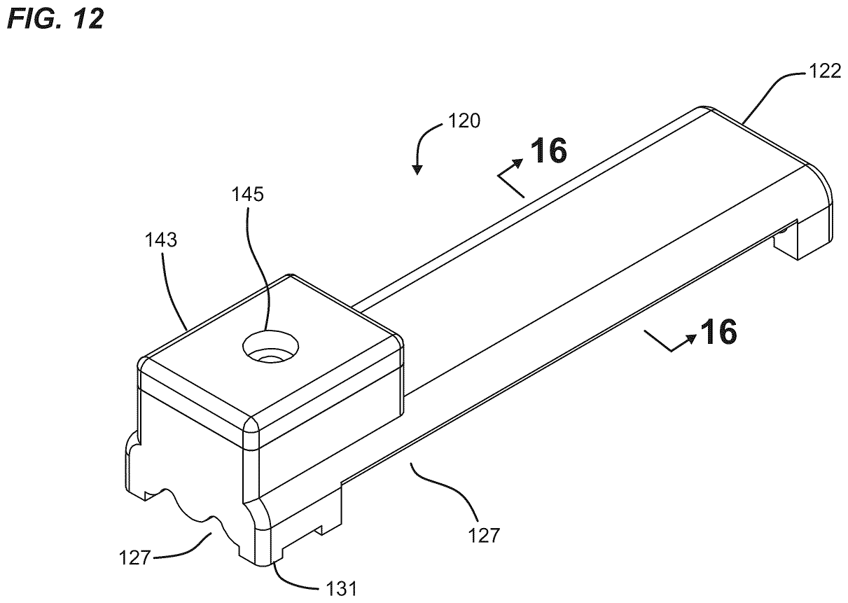

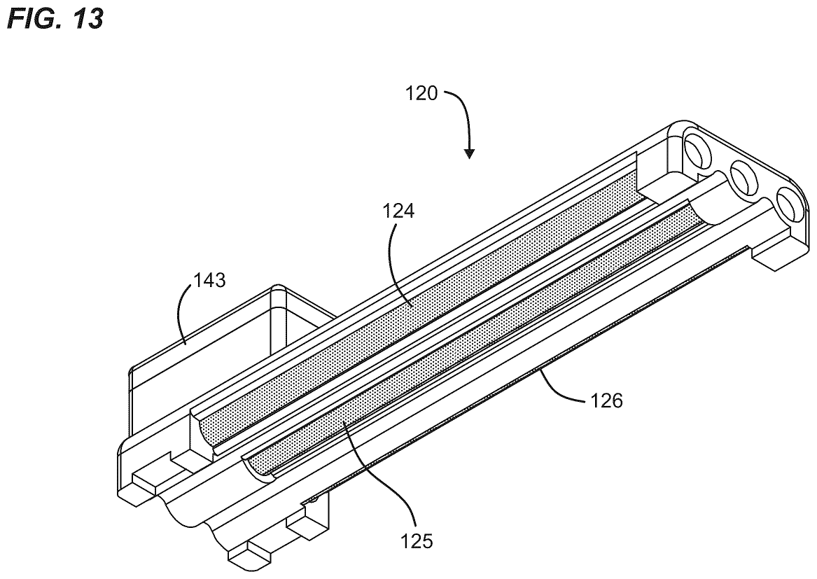

FIGS. 4-11 depict an electrode device 20 in accordance with the principles of the present disclosure for generating biocide in water within a condensate tray such as the condensate trays of FIGS. 1-3 or in other structures such as a drain lines (e.g., within drain line components). The electrode device 20 includes an electrode support structure 22 for supporting and maintaining relative positioning and spacing between first and second electrodes 24, 26. In one example, the support structure 20 has an electrically dielectric construction (e.g., a polymeric construction such as a molded plastic construction). The support structure 20 is configured to maintain the first and second electrode electrodes 24, 26 at a relative positioning with respect to one another (e.g., to maintain a spacing suitable for electrically generating biocide within the condensate water while preventing short circuiting). The support structure 20 also functions to position the first and second electrodes at predetermined positions (e.g., predetermined vertical spacings) relative to a support structure such as the bottom of a condensate tray when the electrode device 20 is mounted in the condensate tray or the bottom of a drain line component when the electrode device 20 is mounted in the drain line component. The electrode device 20 has a length L and a width W. At least the first electrode 24 is a bio-inhibiting conductor that includes a bio-inhibiting material (e.g., copper) that can be released into water of the condensate tray in response to electrical current flowing through water between the electrodes 24, 26. In one example, the first electrode 24 is a bio-inhibiting conductor functioning as an anode and the second electrode 26 is not a bio-inhibiting conductor (e.g., has a stainless steel or titanium construction) and functions as a cathode.

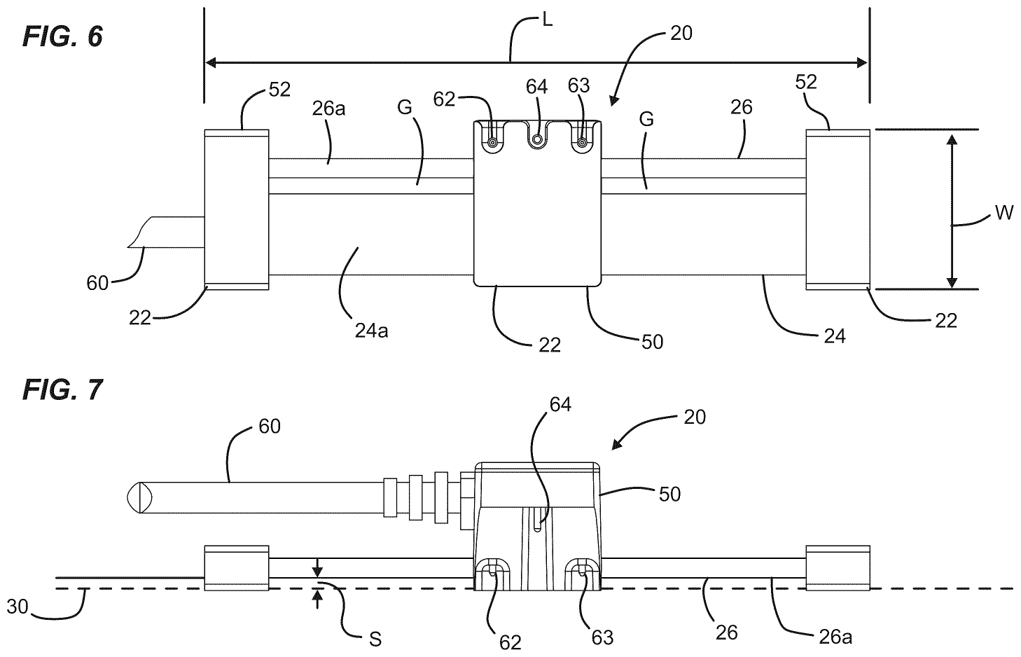

In the depicted example, the support structure 22 defines a base reference plane 30 that coincides with a support surface of a component at which the electrode device 20 is installed (e.g., the bottom of the condensate tray when the electrode device 20 is supported within the tray). The first and second electrodes 24, 26 are supported by the support structure 22 above the base reference plane 30. The first and second electrodes 24, 26 include water contact surfaces 24a, 26a (see FIG. 6) that are exposed and that face toward the base reference plane 30. In this way, when the electrode device is installed in a condensate tray or drain component, the water contact surfaces 24a, 26a face downwardly and oppose the bottom of the condensate tray or drain component. In one example, the water contact surfaces 24a, 26a having lengths that extend along (e.g., parallel to) the base reference plane 30 and along the length L of the electrode device 20. The water contact surfaces 24a, 26a are configured such that when the electrode device 20 is installed in the condensate tray or drain component, water flowing in the tray or drain component flows directly under and contacts the water contact surfaces 24a, 26a and functions as an electrolyte for allowing electrical current to flow through the water between the first and second electrodes 24, 26 causing biocide from the first electrode 24 to be released into the water. It will be appreciated that the water fills a vertical spacing/gap between the water contact surfaces 24a, 26a and the bottom of the tray or drain component. In certain examples, the water contact surfaces 24a, 26a are vertically spaced from the base reference plane 30 by a spacing S in the range of 1-3 millimeters. In certain examples, the water contact surfaces 24a, 24b are vertically spaced from the base reference plane 30 by a spacing S less than or equal to 3 millimeters.

The electrode support structure 22 is depicted including a central main body 50 and outer supports such as feet 52. The central main body 50 is located at a central region of the length of the electrode device 20 and the feet 52 are at ends of the length. The first and second electrodes 24, 26 extend through the main body 50 and terminate within the feet 52. The electrodes 24, 26 are fully exposed at regions between the main body 50 and the feet 52. The electrode support structure 22 has an open configuration with open space corresponding to the exposed regions that allows water to flow through the electrode device 20 in the width orientation W when the electrode device 20 is installed in a condensate tray. The first and second electrodes 24, 26 are elevated relative to the base reference plane 30 and therefore do not interfere with water flowing through the electrode device in the width or length orientation (i.e., the water can flow directly under the first and second electrodes 24, 26). In cases where it is desirable to permit flow through the electrode device 20 in two transverse orientations (e.g., through the electrode device along the width orientation and through the electrode device along the length orientation), one or more water flow passages can be integrated into the feet 52 to allow flow through/under the feet in an orientation along the length L of the electrode device 20. As depicted, a gap G exists between the first and second electrodes 24, 26 at the fully exposed regions. In other examples, the electrode support structure 22 can include portions that fill this gap G and cover portions of the electrodes 24, 26 that face toward each other. The addition of this type of structure can reduce the likelihood of short-circuiting between the first and second electrodes 24, 26.

The first and second electrodes 24, 26 can have different shapes and/or sizes and/or configurations from each other. As depicted, the first electrode 24 is substantially larger than the second electrode 26. In cases where the first electrode 24 is maintained constantly as the biocide generator, the increased size assists in increasing the life of the electrode device because the increased size provides more biocide material mass to be consumed before depletion. In the depicted example, the first electrode 24 is a rectangular bar and the second electrode 26 is a cylindrical rod. In certain examples, the water contact surface 24a of the first electrode 24 is at least 2, 3 or 4 times as large as a water contact surface 26a of the second electrode 26. In the depicted example, the water contact surface 24a of the first electrode 24 is planar and the water contact surface 26a of the second electrode 26 is curved.

The electrode device 20 can include an electrical cord 60 (e.g., an electrical cable) for providing electrical power for driving the flow of electrical current between the first and second electrodes 24, 26 when the electrodes 24, 26 are in contact with water. The electrical cord 60 can include first and second wires that respectively connect to the first and second electrodes 24, 26 at connection locations protected within the main body 50. The wires can connect to a current source (e.g., a constant current source or a variable current source) of a controller. The controller and the electrode device 20 can together form an electrolytic biocide generating system. In certain examples, the current source of the controller can use a constant voltage (e.g., greater than 8 volts, or greater than 10 volts, or greater than 12 volts, or in the range of 8-15 volts) to drive the flow of electrical current between the electrodes 24, 26. The power for driving current between the first and second electrodes is preferably DC power (Direct Current power). The magnitude of the constant voltage can be selected such that sufficient electrical current is generated between the electrodes to generate sufficient biocide even under the worse-case scenario (e.g., the lowest water conductivity anticipated). In other examples, the magnitude of the applied voltage at the first and second electrodes 24, 26 can be varied to vary electrical current based on factors such as water flow rate, the conductivity of the water being treated or other factors. In certain examples, the electrical cord 60 can include additional wires for connecting the controller to one or more sensing probes of the electrode device. For example, first and second conductivity probes 62, 63 (see FIGS. 6 and 7) supported by the main body 50 can be coupled to the controller by wires in electrical cord 60. In certain examples, data/readings generated by the probes 62, 63 can be used to determine the conductivity of the water being treated. For example, an AC electrical signal can be applied across the probes 62, 63 wherein a magnitude of the signal transferred across the probes 62, 63 can be used to determine conductivity. Also, a blockage detection probe 64 (see FIGS. 6 and 7) can be wired to the controller through the cord 60 and used to determine if the condensate tray being treated becomes plugged. The probe 64 can be positioned higher than the conductivity probes 62, 63 and the electrodes 24, 26. The location of a lower tip of the of the probe 64 can be selected to correspond to a depth of water in the condensate tray indicative of the drain of the condensate tray being plugged. When water reaches a level of the probe 64 and contacts the probe 64, there is a change/variation in a conductivity measurement as compared to when the probe 64 is only exposed to air (e.g., conductivity between the probe 64 and one of the probes 62, 63 or between the probe 64 and one of the electrodes 24, 26). This change in conductivity is indicative of a high-water level and the controller can issue an alert to the appropriate person to make them aware of the issue. In certain examples, the alert can be a local alarm at the controller, a local alarm activated by hardwire or local wireless signals generated by the controller, an alert activated by a signal sent from the controller via hard wire or wirelessly over a local area network and over the internet to generate an alarm at any number of smart devices, and/or an alarm sent to smart devices over a cellular network.

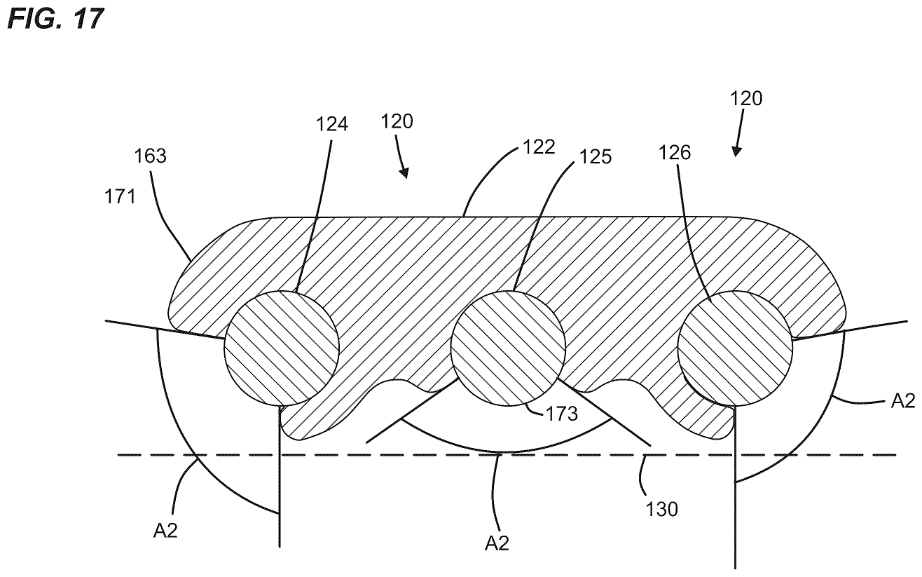

FIGS. 12-16 depict another electrode device 120 in accordance with the principles of the present disclosure for generating biocide in water within a condensate tray such as the condensate trays of FIGS. 1-3 or within a drain component. The electrode device 120 includes a support structure 122 (e.g., a dielectric support structure). The electrode device 120 can also include first and second electrodes supported by the support structure 122 with at least one of the electrodes being a bio-inhibiting conductor. In the depicted example (as best shown at FIG. 16), the electrode device includes first, second and third electrodes 124-126 which are depicted as being retained in spaced-apart, parallel relation with respect to each other by the support structure 122. In the depicted example, the first and third electrodes 124, 126 are bio-inhibiting conductors and function as anodes, and the second electrode 125 functions as a cathode. In one example, the first and third electrodes 124, 126 include a composition including a bio-inhibiting material such as copper. In one example, the second electrode includes a composition including a metal such as stainless steel or titanium. At FIGS. 13-15, the first, second and third electrodes 124-126 have been shaded to enhance visibility.

In an alternative example, the first, second and third electrodes 124-126 can all be bio-inhibiting electrodes. In such an example, the polarity states of the electrodes 124-126 can be periodically switched to extend the life of the electrode device 120. For example, in a first polarity state, the first and third electrodes 124, 126 are anodes and the second electrode 125 is a cathode; while in a second polarity state the first and third electrodes 124, 126 are cathodes and the second electrode is an anode. To maximize the life of the electrode device 120, the electrode device 120 can be operated in the first polarity state for longer periods or for a longer duration than the electrode device is operated in the second polarity state. For example, the electrode device 120 can be programmed to be operated in the first polarity state for two-thirds of the overall operating time and to be operated in the second polarity state for one-third of the overall operating time. Thus, the polarity switching can be controlled such that over time the electrode device 120 operates in the first polarity state for twice as long as the electrode device operates in the second polarity state.

The first, second and third electrodes 124-126 include portions embedded in (e.g., molded into) and covered by the support structure 122, and portions that are exposed. In one example, at least portions of the exposed portions of the first, second and third electrodes 124-126 are adapted to face in a first direction dl (e.g., downwardly) when the electrode device 120 is installed within a condensation collection system. The electrode device 120 preferably includes an electrical cord with wires that electrically connect to the first, second and third electrodes 124-126 for allowing a controller having an electrical current source to drive electrical current flow between the second electrode 125 and the first and third electrodes 124, 126 when the first, second and third electrodes 124-126 are all contacting water within a condensate tray or drain component. The support structure 122 can include a top tower 143 where the electrical cord can couple to the support structure 122 (e.g., see opening 145 in the tower 143 for allowing the cord to extend into the tower 143). Within the tower 143, wires of the electrical cord can be broken out and routed to the electrodes 124-126 while being protected within the tower 143. The electrode device 120 can also include additional probes (e.g., probes 62-64 described above) for the purpose of taking conductivity measurements to determine the conductivity of the water being treated and/or to detect the presence of water or absence of water beneath the electrode device and/or for detecting high water levels indicative of a drain plug.

The support structure 122 includes a base structure configured to contact a bottom of the condensate tray or drain component when the electrode device is installed within the condensate tray or drain component. In one example, the base structure can include downward projections 131 (e.g., posts, legs, supports, etc.). The support structure and the first, second and third electrodes 124-126 define an open region 127 for allowing water flowing along the bottom of the tray or drain component to flow under and through the electrode device 120 to prevent damming of the water within the condensate tray or drain component. The open region 127 includes flow paths for allowing the water to flow in first and second perpendicular orientations 133, 135 under and through the electrode device 120. In one example the first orientation 133 coincides with a length L of the electrode device 120 and the second orientation 135 coincides with a width W of the electrode device 120. While the electrodes 124-126 are depicted as having circular cross-sectional shapes, alternative cross-sections shapes (e.g., polygonal such as square, hexagonal, triangular, etc. or other shapes) can also be used.

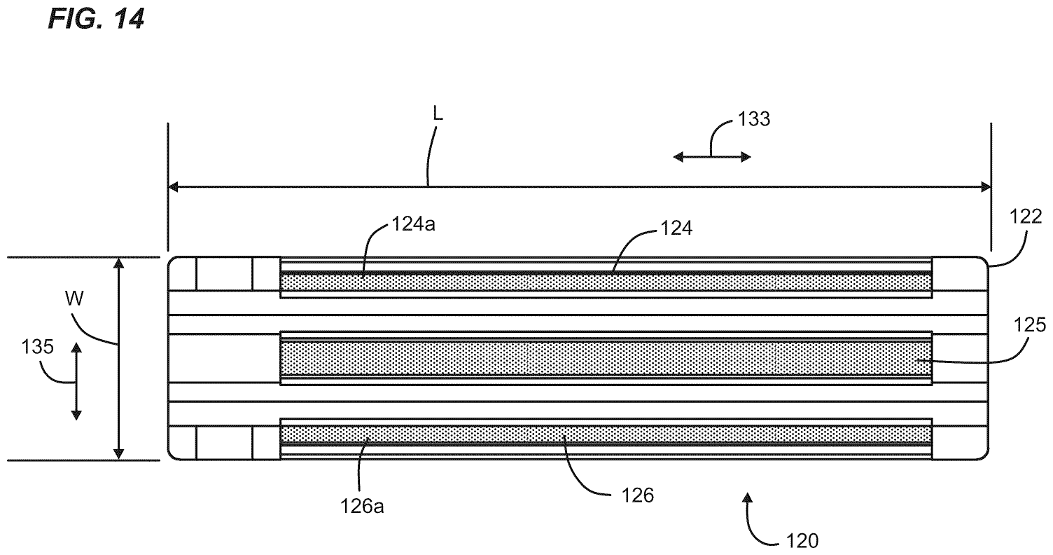

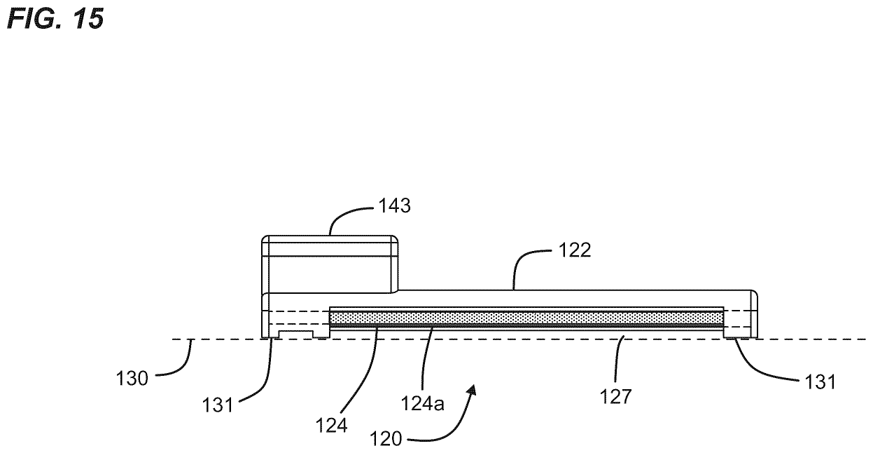

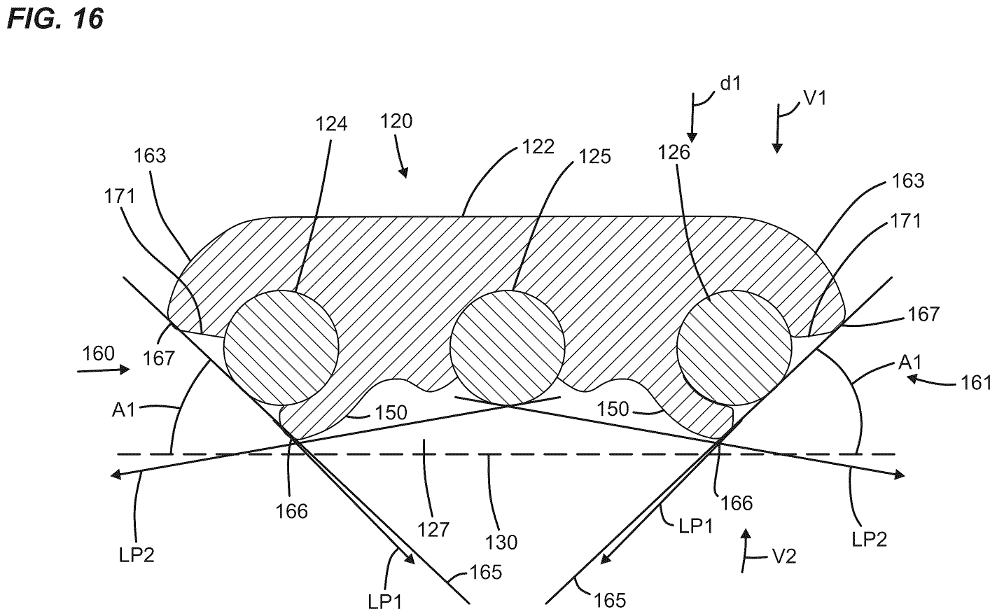

As depicted, the first, second and third electrodes 124-126 include water contact surfaces 124a, 125a and 126a (see FIG. 14) that are exposed and that face at least partially in a first direction (e.g., a downward direction) when the electrode device 120 is installed in the condensate tray. The base structure defines a base reference plane 130 (see FIGS. 15 and 16) that coincides with the bottom of the condensate tray or drain component when the electrode device 120 is installed in the condensate tray or drain component. An open vertical space is defined between the water contact surfaces 124a, 125a and 126a and the base reference plane 130 for allowing the water in the condensate tray or drain component to flow directly beneath the water contact surfaces 124a, 125a and 126a. When the electrode device 120 is installed in the condensate tray or drain component, the open vertical space extends from the water contact surfaces 124a, 125a and 126a to the bottom of the tray or drain component. The water contact surfaces 124a, 125a and 126a have lengths that extend along the lengths of the first, second and third electrodes 124, 125 and 126 and also extend along the length L of the electrode device 120 and widths that extend along widths of the first, second and third electrodes 124, 125 and 126 and also extend along the width W of the electrode device 120. In certain examples, at least two of the electrodes 124-126 include exposed water contact surfaces that face at least partially in the same direction (e.g., toward the base reference plane 130; downwardly).

Referring to FIG. 16, the electrode device 120 has a configuration adapted to inhibit short circuiting of the electrodes. During biocide production, particularly under low water flow conditions, the biocide production process can generate conductive material (e.g., a material that results from oxidation, etc.) that if allowed to bridge a spacing between an anode and a cathode can cause short circuiting. To inhibit short circuiting, numerous features have been incorporated into the design of the electrode device 120.

One aspect of the design of the electrode device 120 relates to construction the support structure 122 to provide differential coverage of the electrodes 124-126 from different (e.g., opposite) viewing directions. In a preferred example, the electrodes 124-126 are all fully covered by the support structure 122 from a first viewing direction V1 (e.g., the electrodes 124-126 are not visible from the first viewing direction V1) and all are not fully covered by the support structure from an opposite second viewing direction V2 (e.g., the electrodes 124-126 are exposed so that at least a portion of each electrode is visible from the second viewing direction). In one example, the first viewing direction V1 is a downward direction looking at a first side (e.g., top side) of the electrode device 120 and the second viewing direction V2 is an upward direction looking at an opposite second side (e.g., a bottom side) of the electrode device 120. In use over time, conductive material can accumulate on (e.g., be deposited upon) the top side of the electrode device 120. By covering the top sides of the electrodes 124-126 with a dielectric material such as is provided by the support structure 122, the accumulated material accumulates on the dielectric material and is prevented from short circuiting the electrode device 120.

Another aspect of the design of the electrode device 120 relates to constructing the support structure 122 to obstruct (e.g., block, occlude, etc.) linear paths (e.g., lines of sight, vector lines, etc.) between any portions of the anodes and any portions of the cathodes of the electrode device 120. If an unobstructed linear path (e.g., an unblocked linear path, an open linear path) exists in either direction between an anode and a cathode, conductive material generated by oxidation can collect (e.g., accumulate; build-up; etc.) along the linear path and create an electrical short. A dielectric material such as the material of the support structure 122 preferably eliminates any unobstructed linear paths between the electrodes 124-126 (e.g., from the first electrode 124 to the second electrode 125; from the second electrode 125 to the first electrode 124; from the second electrode 125 to the third electrode 126; and from the third electrode 126 to the second electrode 125). Thus, the support structure 122 is configured to eliminate any unobstructed linear vector lines that intersect an anode a cathode of the electrode device 120. In one example, path between an anode and a cathode is as non-linear as possible while also enabling a suitable electrical distance between the anode and the cathode through water such that biocide is electrolytically generated.

As depicted, linear path LP1 (e.g., linear vector) is the unobstructed linear path that is directed most closely from the first electrode 124 to the second electrode 125. As depicted, the linear path LP1 does not intersect both the first and second electrodes 124, 125; but only intersects the first electrode 124. Any linear path angled more directly from the first electrode 124 toward the second electrode 125 will be obstructed by a projection 150 (a linear path blocking projection) of the support structure 122. The projection 150 is a separator (e.g., divider, barrier, liner path blocking obstruction, etc.) that projects from a main body of the support structure 122 (e.g., in a downward direction) and has a length that extends along lengths of the first and second electrodes 124, 125. The projection 150 preferably projects lower than the first electrode 124 and the second electrode 125. A distal end 151 of the projection 150 is spaced from (e.g., elevated above) the base reference plane 130 such that the projection 150 does not block water flow beneath the electrode device 120. Linear path LP2 is the is the unobstructed linear path that is directed most closely from the second electrode 125 to the first electrode 124. As depicted, the linear path LP2 does not intersect both the first and second electrodes 124, 125; but only intersects the second electrode 125. The linear paths LP1 and LP2 corresponding to the first and second electrodes 124, 25 intersect each other; and the linear paths LP1 and LP2 corresponding to the second and third electrodes 125, 126 intersect each other.

It will be appreciated that certain conductive material generated during biocide generation can have buoyant properties that cause the material to float. In certain examples, the sides 160, 161 of the electrode device 120 adjacent the first and third electrodes 124, 126 are configured to minimize the collection of buoyant conductive material or to reduce the risk of short circuiting caused by the collection of buoyant conductive material. In certain examples, the sides 160, 161 are configured to allow floating material to float upwardly and slough/shed upwardly past the sides 160, 161 rather than be collected. In one example, the sides 160, 161 each include a coverage extension 163 that extends over a respective one of the first and third electrodes 124, 126. In one example, a reference line drawn 165 from an outer extent 166 of the projection 150 to an outer extent 167 of the coverage extension 163 is angled upwardly with respect to the base reference plane 130 at an angle A1 of at least 20 degrees, or at least 30 degrees, or at least 40 degrees, or in the range of 20-60 degrees, or in the range of 30-60 degrees. In one example, the reference line 165 does not intersect the electrode 124, 126 at the corresponding side 160, 161. In one example, the reference line 165 is tangent to the electrode 124, 126 at the corresponding side 160, 161. The upward angle A1 is configured to limit the collection of buoyant conductive material that floats upwardly from beneath the electrode device 120. In one example, the coverage extensions 163 include downwardly facing surfaces 171 (e.g., overhang surfaces) that extend outwardly from the side electrodes 124, 126 and angle upwardly as the downwardly facing surfaces 171 extend away from their corresponding electrode 124, 126.

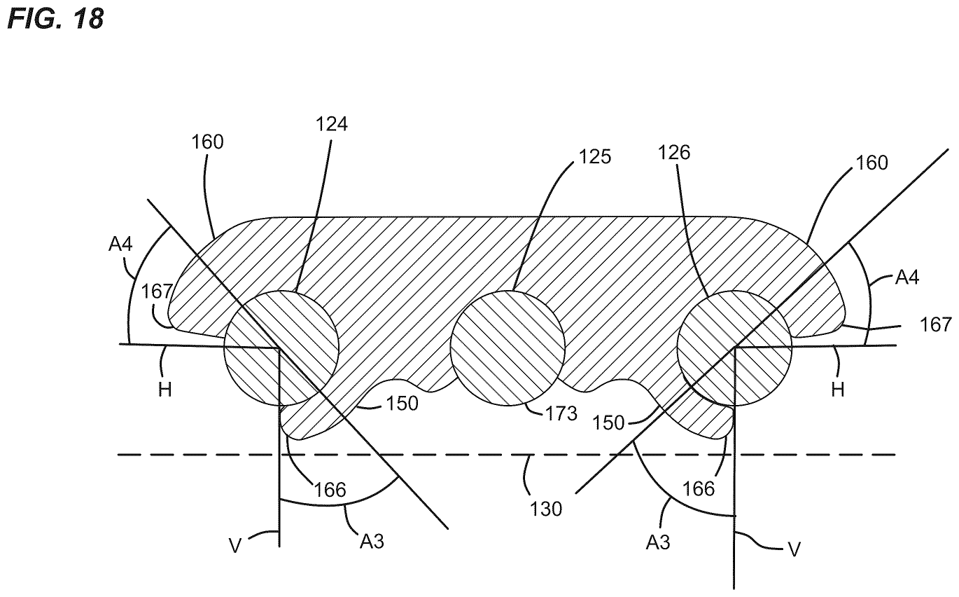

In certain examples, an angular section A2 (see FIG. 17) of each of the side electrodes (i.e., the first and third electrodes 124, 126 as depicted) is exposed. In one example, the angular section A2 defines an angle in the range of 150 degrees to 60 degrees, or in the range of 130 degrees to 70 degrees, or in the range of 110 degrees to 80 degrees, or in the range of 95-85 degrees. In certain examples, when viewed in transverse cross-section as shown at FIG. 17, at least 60, 70, 80 or 90 percent of an outer surface of the angular section A2 of the first and third electrodes 124, 126 is at a bottom side of each of the side electrodes 124, 126 and faces at least partially in a downward direction (e.g., at least partially toward the base reference plane 130) when the electrode device 120 is installed. As depicted, 100 percent of an exposed outer surface 173 of the second electrode 125 faces at least partially toward the base reference plane 130 (e.g., downwardly in direction d1). The exposed outer surface 173 of the second electrode 125 can have an angle as specified above with respect to the angular section A2.

In certain examples, as shown at FIG. 18, each of the projections 150 occupies at least a portion of a 45 degree angular region A3 extending from vertical line V at a center of one of the side electrodes 124, 126 toward the second electrode 125. In certain examples, the projections occupy at least 20, 40, 60, 80 or 100 percent of the angular region A3. In certain examples, the outer extents 166 of the projections 150 are offset no more than 5, 10, 15 or 20 degrees from the vertical line V in a direction toward the second electrode 125. In certain examples, the projections 150 can be intersected by the vertical lines V.

In certain examples, as shown at FIG. 18, each of the coverage extensions 160 occupies less than all of a 45 degree angular region A4 extending upwardly from a horizontal line H at a center of one of the side electrodes 124, 126. In certain examples, the coverage extensions 160 occupy less than all and at least 75 percent of the angular regions A5.

In certain examples, the first and third electrodes 124, 126 when viewed in transverse cross section as shown at FIG. 16 have downwardly facing sides and upwardly facing sides, and wherein the downwardly facing sides are more exposed than the upwardly facing sides. In certain examples, the upwardly facing sides are fully covered when viewed from above the electrode device 120 and at least 40, 45 or 50 percent of the downwardly facing sides are exposed when viewed from below the electrode device 120.

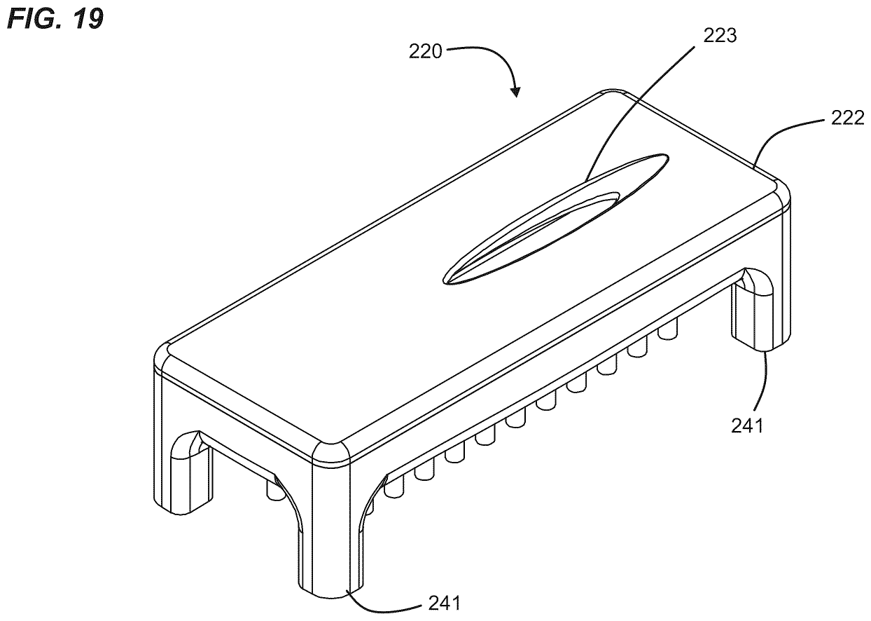

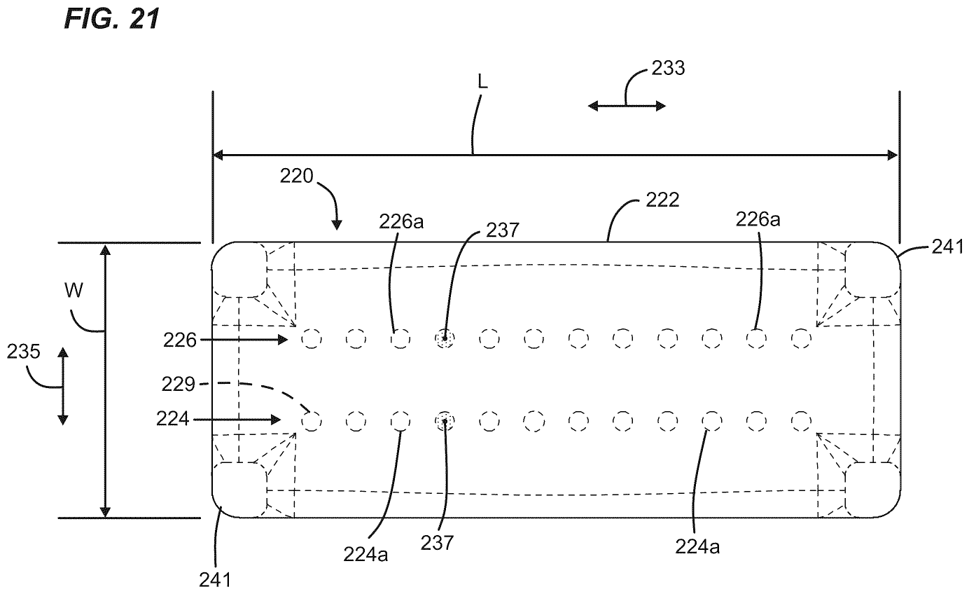

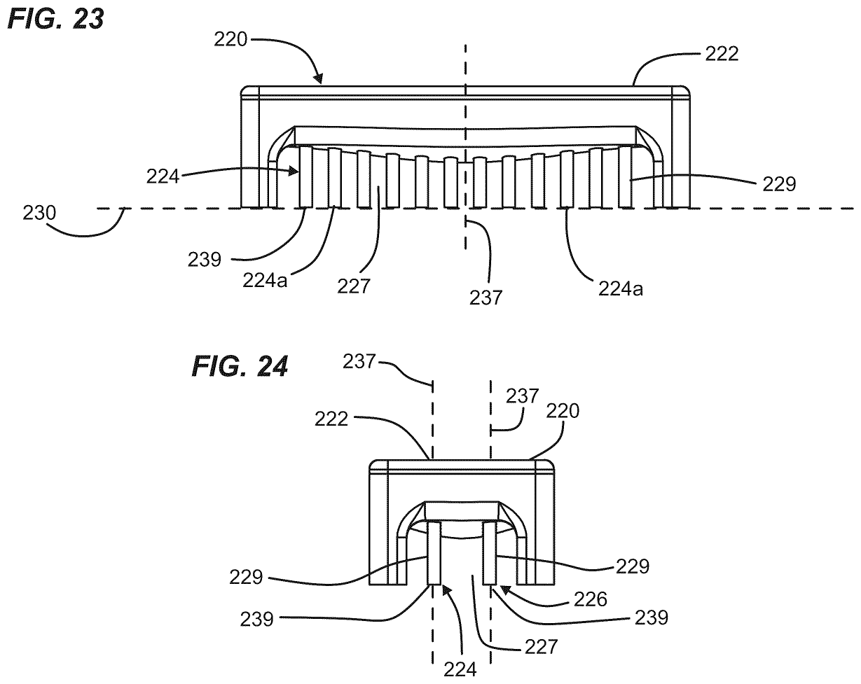

FIGS. 19-24 depict another electrode device 220 in accordance with the principles of the present disclosure for generating biocide in water within a condensate tray such as the condensate trays of FIGS. 1-3 or a drain component. The electrode device 220 includes a support structure 222 (e.g., a dielectric support structure). The electrode device 220 can also include first and second electrodes 224, 226 retained in spaced apart relation relative to each other by the support structure 222. At least the first electrode 224 is a bio-inhibiting conductor. The first second electrodes 224, 226 include portions embedded in a downwardly facing portion of the support structure 222 and portions that project downwardly from the downwardly facing portion of the support structure 222. The electrode device 220 preferably includes an electrical cord with wires that electrically connect to the first and second electrodes 224, 226 for allowing a controller to having an electrical current source to drive electrical current flow between the first and second electrodes 224, 226 when the first and second electrodes 224, 226 are both contacting water within a condensate tray. The electrode device 220 can also include additional probes such as the probes 62-64 described above and the cord can include wires corresponding to the probes for allowing the controller to conduct sensing operations. The cord can enter the support structure 222 through an opening 223 defined by the support structure 222 and the wires can be broken out within the support structure and routed to their corresponding electrodes/probes. In certain examples, both the first and second electrodes 224, 226 can be bio-inhibiting conductors and the electrode device 220 can include a controller that alternatingly reverses a polarity of the electrical power applied to the first and second electrodes 224, 226 to increase a life of the electrode device 220.

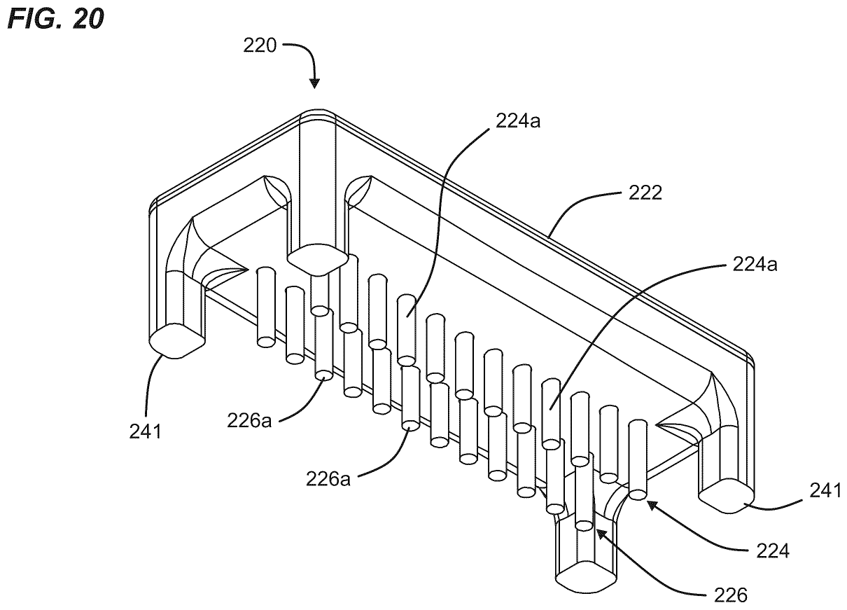

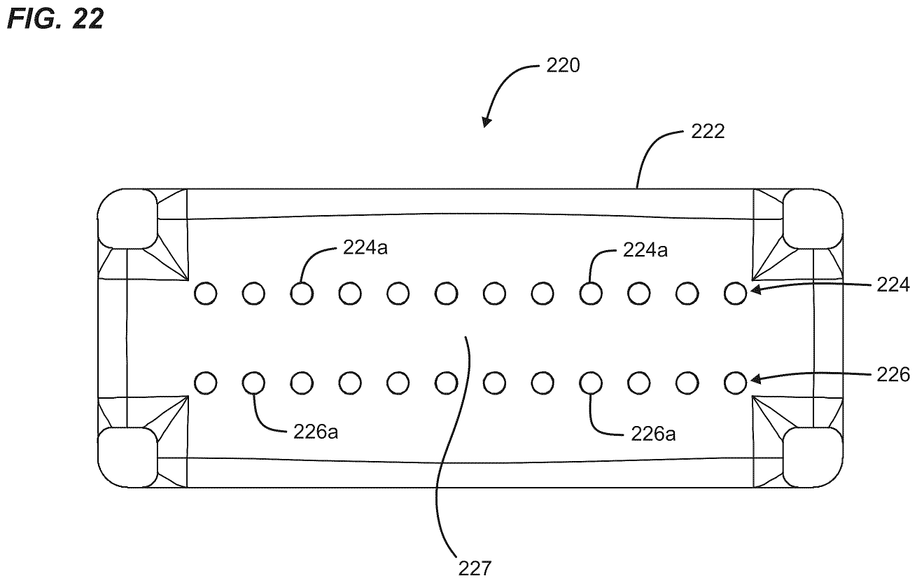

Referring to FIGS. 20-22, The first electrode 224 is defined by a first plurality of electrode members 224a having lengths that are perpendicularly oriented relative to a base reference plane 230 of the electrode device 220 and the second electrode 226 is defined by a second plurality of electrode members 226a having lengths that are perpendicularly oriented relative to the base reference plane 230 (shown at FIG. 22). The first electrode members 224a are arranged in a first row and the second electrode members 226a are arranged in a second row parallel to the first row. The first and second electrode members 224a, 226a each extend lengthwise along a corresponding electrode axis 237 oriented perpendicular with respect to the base plane 230. The first electrode members 224a are electrically connected to a first electrical power wire of the electrical cable and the second electrode members 226a are electrically connected to a second electrical power wire of the electrical cable such that the first electrode members 224a have a first charge and the second electrode members 226a have an opposite second charge. The first and second electrode members 226a, 226b have water contact surfaces 229 that are exposed and that face radially outwardly from the electrode axes 237. In the depicted example, the first and second electrode members 224a, 226b have circular transverse cross-sectional shapes so that the water contact surfaces 229 are defined by curved surfaces (e.g., cylindrical surfaces about the axes 237). In other examples, the first and second electrode members 224a, 226 alternative transverse cross-sectional shapes (e.g., triangular, square, hexagonal, etc.) such that the water contact surfaces can be defined by flats. Bottom ends 239 of the first and second electrode members 224a, 226a can also define water contact surfaces.

The electrode device 220 includes a base structure configured to contact a bottom of the condensate tray or drain component when the electrode device is installed within the condensate tray or drain component. In one example, the base structure can include the bottom ends 239 of the first and second electrode members 224a, 226a. The bottom ends 239 can coincide with and define the base plane 230. The base structure can also include legs 241 (e.g., dielectric projections) of the support structure 222. The support structure and the first and second electrode members 224a, 226a define an open region 227 for allowing water flowing along the bottom of the tray or drain component to flow under the support structure 222 and through the electrode device 220 (e.g., between the first electrode members 224a and between the second electrode members 226a so as to flow through the first and second electrodes 224, 226) to prevent damming of the water within the condensate tray. The open region includes flow paths for allowing the water to flow in first and second perpendicular orientations 233, 235 under and through the electrode device 220. In one example the first orientation 233 coincides with a length L of the electrode device 220 and the second orientation 235 coincides with a width W of the electrode device 220.

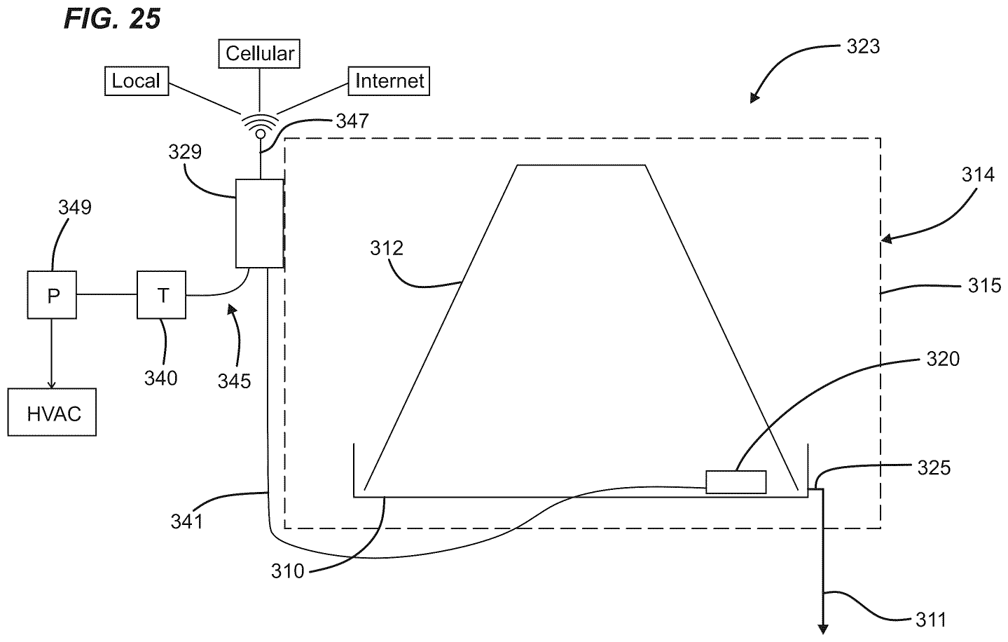

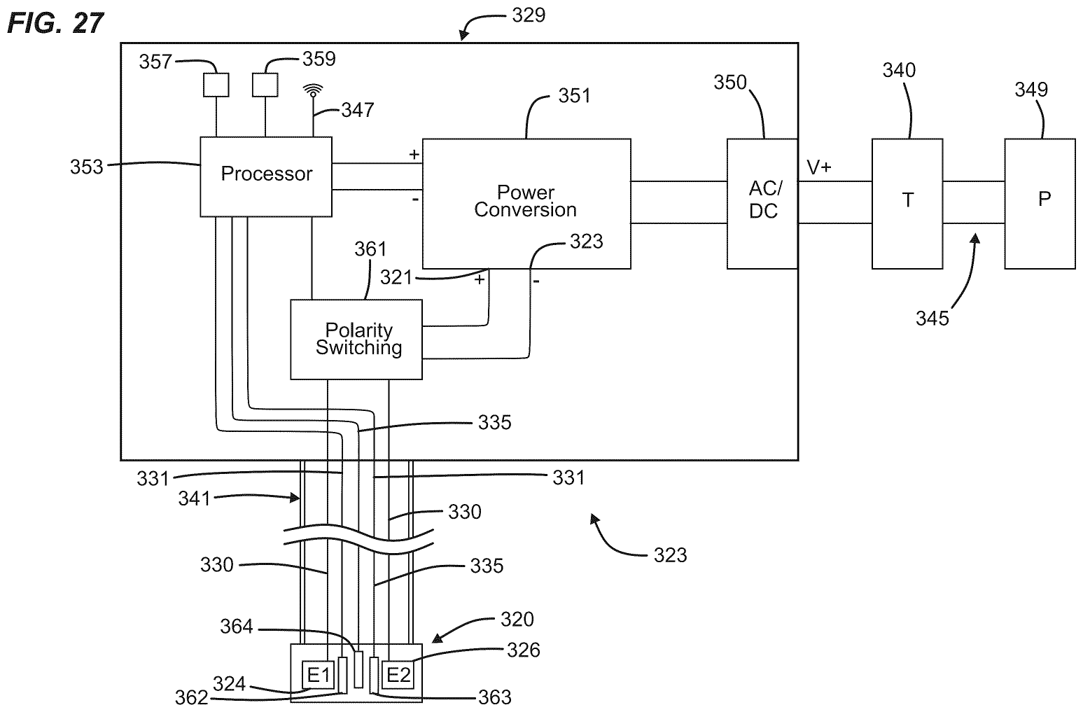

FIG. 25 depicts an evaporator unit 314 including a housing 315 configured to be incorporated within a duct system defining an air plenum. The evaporator unit 314 includes an evaporator 312 (e.g., an evaporator coil) positioned within the housing 315 and a condensate tray 310 positioned within the housing 315 beneath the evaporator 312. The condensate tray 310 includes a gravity flow drain line 311. An electrode device 320 (e.g., electrode device 20, electrode device 120, electrode device 220, electrode device 520 or other electrode devices) is mounted adjacent the drain line 311. In one example, the electrode device 320 can be positioned directly at (e.g., directly over or in front of) a drain port 325 of the drain line 311. The electrode device 320 is part of an electrolytic biocide generating system 323 in accordance with the principles of the present disclosure. The electrode device 320 generates biocide (e.g., copper ions) in the water of the condensate tray 310 to prevent clogging of the drain line 311 at the drain port 325 of the drain line 311 and within the drain line 311. The electrolytic biocide generating system includes a controller 329 for applying electrical current across electrodes 324, 326 (see FIG. 27) of the electrode device 320. The controller 329 can be hard wired to the electrode device 320 by an electrical cord 341 (e.g., an electrical cable) and can be mounted near the evaporator unit 314 (e.g., on the exterior of the housing 315). The electrical cord 341 can include power wires 330 for providing a voltage across the electrodes 324, 326 to drive the flow of electrical current through the water in the condensate tray 310 between the electrodes 324, 326. The electrical cord 341 can also include wires 331 for connecting the controller 329 to conductivity probes 362, 363 of the electrode device 320 and another wire 335 for connecting the controller 329 to a water blockage detection probe 364 of the electrode device 320. The biocide generating system 323 can also include an electrical power cord assembly 345 that can couple to a power source 349 used to power the biocide generating system 323. In one example, the power source 349 can be used for powering the HVAC system in which the evaporator unit 314 is incorporated such that the HVAC system and the biocide generating system 323 are powered by the same power source. In one example, the power source can include a 120-volt AC (alternating current) power source and the electrical power cord assembly 345 can include a transformer 340 for converting the power to 24 volt AC power. The controller 329 can include a communication device 347 such as a wireless transmitter, a wireless receiver and or a wireless transceiver for communicating wirelessly with a local alarm (through a local area network), with smart devices though a cellular network, or with smart devices through wireless connection to the internet wire a local area network. The controller 329 can include an AC/DC converter 350 (e.g., a transformer) for converting the power from the power cord assembly 345 to a DC current which can be supplied to power conversion circuitry 351. The controller can include power isolation circuitry for electrically isolating (e.g., providing a floating reference ground) the controller and the electrodes. The power conversion circuitry 351 can be adapted for converting the power from the converter 350 to a voltage (e.g., in one example a constant voltage suitable for generating sufficient current under all envisioned water conductivity conditions) suitable to be applied across the electrodes 324, 326 (e.g., 8-15 volts DC) and also a voltage suitable for use with powering a data processor 353 (e.g., 3 volts DC) of the controller 329. The controller 329 can include polarity switching circuitry 361 for selectively switching the polarity of the electrodes 324, 326. For example, the electrodes can be switched between a first polarity state in which electrode 324 is connected to a positive charge 321 (e.g., a positive terminal) of an electrical power circuit (e.g., including the power conversion circuitry 351) and the electrode 326 is connected to a negative charge 323 (e.g., ground or reference ground terminal) of the electrical power circuit and a second polarity state in which electrode 326 is connected to the positive charge 321 of the electrical power circuit and the electrode 324 is connected to the negative charge 323 of the electrical power circuit. Polarity switching can be provided in one example by an H-bridge circuit as disclosed by U.S. Pat. No. 11,027,991, which is hereby incorporated by reference in is entirety. The controller 329 can also include a user input interface 357 (e.g., buttons, touch screen or other controls) and a display 359 (e.g., a display screen, indicator lights such as LEDs, etc.). The processor 353 can control operation of the polarity shifting circuitry 361 and can also control the voltage applied across the electrodes 324, 326. The processor 353 can also process data from the probes 363-364 and can interface with the communication device 347. In certain examples, the controller 329 can apply AC signals between the probes 362, 363 to generate data for monitoring conductivity/impedance; and also AC signals with respect to the probe 364 to generate data for monitoring water level in the tray.

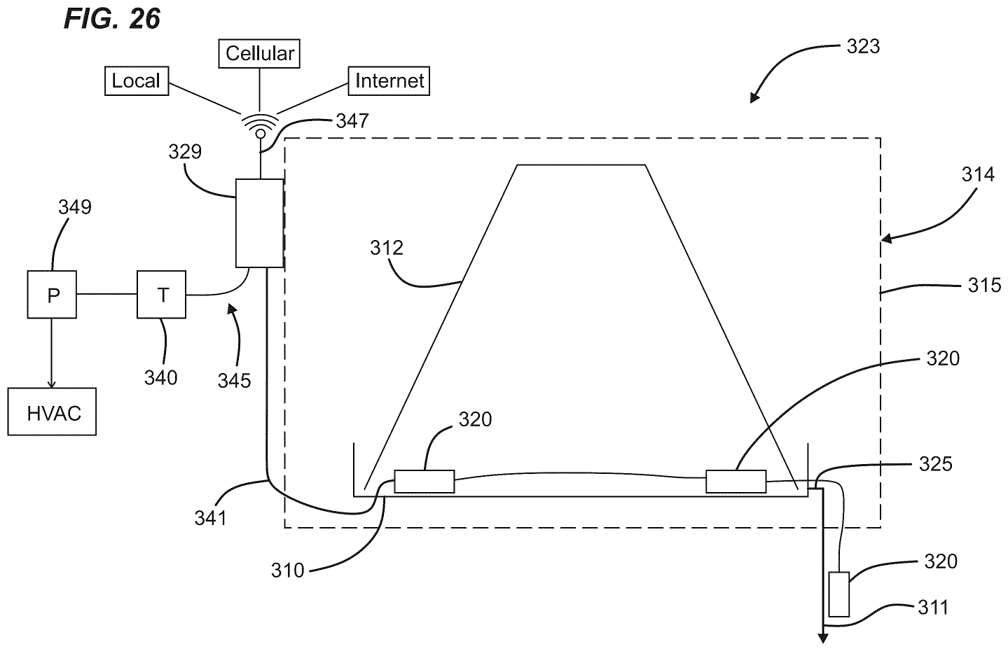

In certain examples, the electrolytic biocide generating system can include multiple sets of electrode devices 320 controlled by the controller 329 (see FIG. 26). The electrode devices 320 can be placed at different locations where biocide ion generation is desired (e.g., in the tray and in the drain line). In certain examples, two, three or more of the electrode devices 320 can be controlled by the controller 329 and positioned at different locations of the water collection and drain system. The electrode devices 320 can be separately wired to the controller 329 thereby allowing the electrode devices 320 to be independently controlled by the controller 329. Alternatively, two or more of the electrode devices 320 can be daily chained together (e.g., connected in series by parallel positive and negative power lines) and controlled together by the controller 329. In certain examples, multiple electrode devices can be installed in the tray and one or more electrode devices can be installed in the drain line with all the electrode devices being controlled together or independently by the controller. For electrode devices installed in the drain line, the electrode devices can be installed in a horizontal section of the drain line, a vertical section of the drain line, or an angled sections of the drain line (e.g., a section angled downwardly with respect to horizontal as the section extends away from the tray; the downward angle is preferably less than 60 degrees or less than 45 degrees, or less than 30 degrees, or less than 20 degrees or less than 10 degrees).

Electrolytic biocide generating systems in accordance with the principles of the present disclosure can include flow-through housings containing a biocide-generating electrode arrangements and which are adapted to be connected in-line as part of gravity drain lines from trays or other structures. The flow-through housings can be coupled in fluid communication with the trays or other structures and can also be coupled in fluid communication with a downstream conduit such as a hose or pipe. The couplings with the trays or other structures and with the downstream conduits can be unitary couplings, bonded couplings, sealed couplings (e.g., sealed with an elastomeric seal, a bonding material, a friction fit, etc.), mechanical couplings (e.g., fittings, press-fit couplers, threaded couplers, mating couplings, etc.) or combinations thereof.

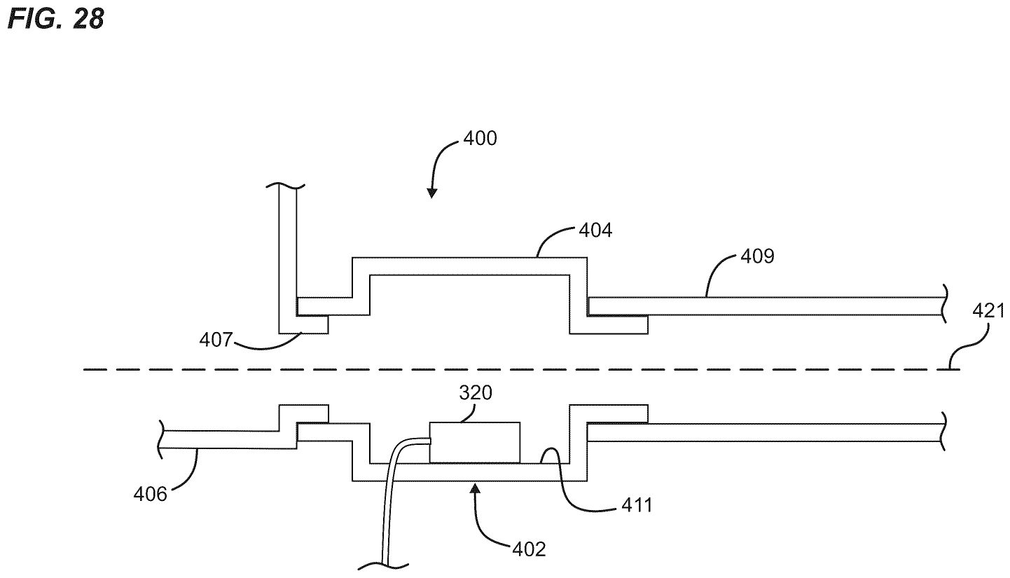

FIG. 28 is a cross-sectional view of a portion of a water collection system 400 including an electrolytic biocide generating system 402 in accordance with the principles of the present disclosure. The electrolytic biocide generating system 402 includes a flow-through housing 404 containing a biocide-generating electrode arrangement (e.g., electrode device 320); the flow-through housing 404 is shown coupled in-line with a gravity drain of the water collection system 400. One end of the flow-through housing 404 is coupled in fluid communication with a drain port 407 of water collection tray 406 (e.g., below an evaporator coil) and an opposite end of the flow-through housing 404 is coupled in fluid communication with an extension 409 of the drain line (e.g., a hose, pipe, tube, flexible tube, etc.). The coupling locations at the ends of the flow-through housing 404 can have any of the configurations described above. The flow-through housing 404 optionally can include a sump 411 at which electrode device 320 is positioned. The flow-through housing 404 includes a central axis 421 parallel to the direction of water flow. Preferably, the flow-through housing 404 is installed with the central axis 421 horizonal or angled (e.g., angled downwardly as the axis extends away from the tray 406) and with the electrode device 320 located at a bottom of the housing 404 to be in the best position to contact water flowing through the flow-through housing 404 (e.g., even under low flow conditions). In the case in which a sump is present, the sump assists in ensuring the water in the housing has a sufficient depth to contact the electrodes of the electrode device 320 such that the water is sufficiently treated with biocide. In the case in which the sump is present, the electrode device 320 can be controlled by a control system that monitors the concentration of biocide in the water of the sump (e.g., via monitoring electrical conductivity) and reduces or stops the production of biocide when the concentration of biocide in the water reaches a pre-determined threshold. In this way, the over production of biocide is prevented under low-flow or no-flow water conditions in which little to no water is flowing through the drain line, but water is still present in the sump. In certain examples, the extension 409 has an inner cross-dimension (e.g., inner diameter) less than or equal to 1.5 inches or less than or equal to 1 inch or less than or equal to 0.75 inches.

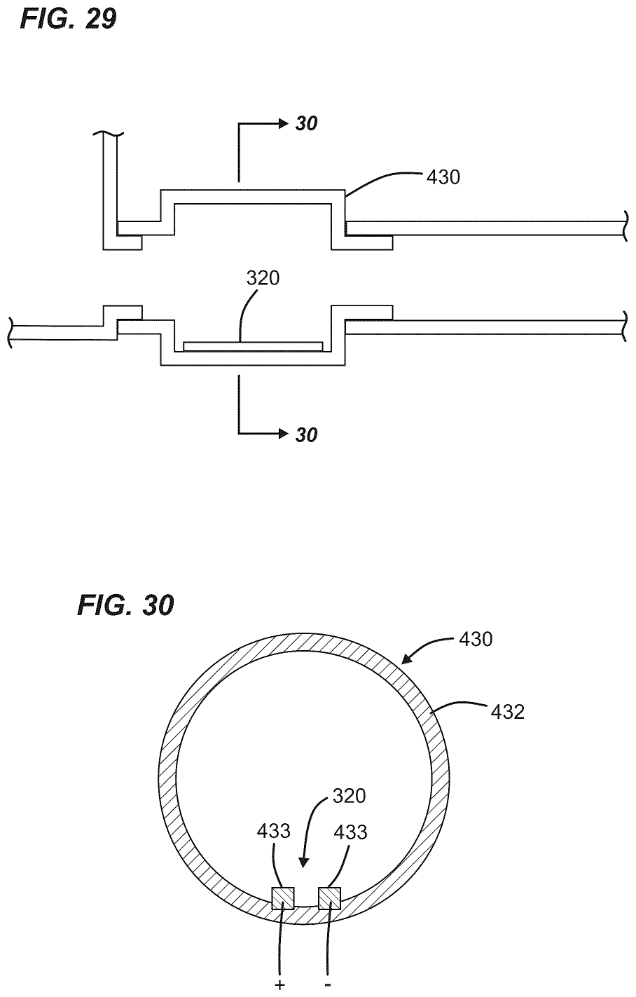

FIGS. 29 and 30 depict an alternative flow-through housing 430 coupled in-line with the gravity drain of the water collection system 400. The flow-through housing 430 has the same configuration and is used in the same way as the flow through housing 404, except in the flow-through housing 430 the electrode device 320 is integrated with a wall 432 of the flow-through housing 430. For example, electrodes 433 (anodes and cathodes) of the electrode device 320 are integrated with (e.g., molded into, embedded in, etc.) the wall 432. The wall 432 preferably has a dielectric construction (e.g., a plastic construction).

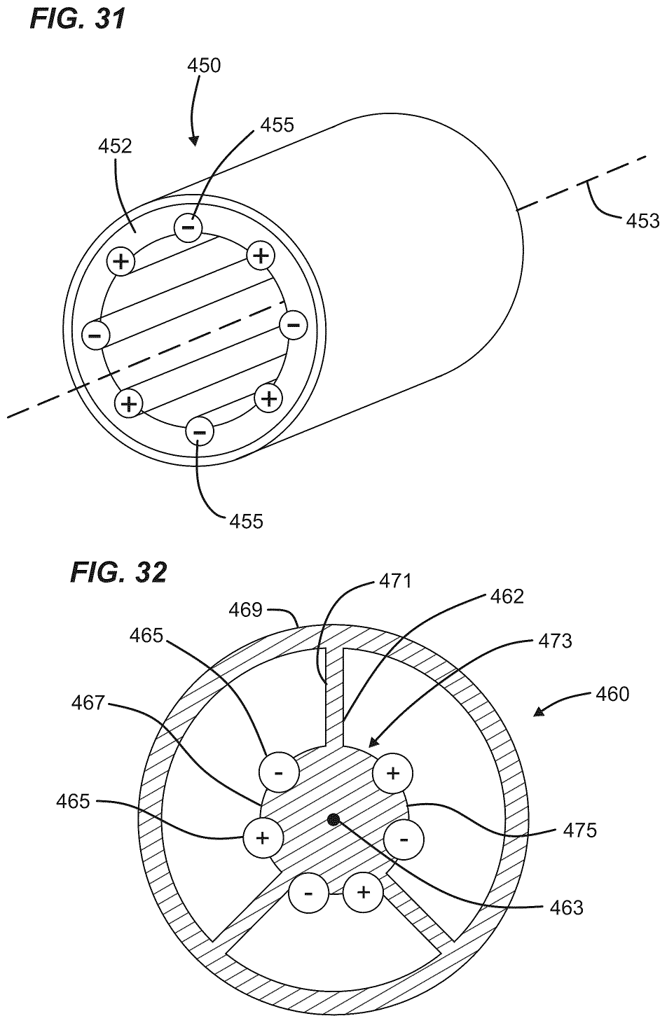

FIG. 31 depicts another electrode configuration 450 for generating biocide in a drain line such as the drain line from a condensate tray for collecting condensate from an evaporator coil. The electrode configuration 450 includes a substrate 452 defining an axis 453 adapted to run parallel to a direction of water flow through the drain line in which the electrode configuration is located. The substrate 452 can have a dielectric construction and can support a plurality of electrodes 455 (e.g., positive and negative electrodes with at least one or more electrodes being a bio-inhibiting conductor). In certain examples, the electrodes 45 can include at least 2, 4, 6, 8 or more electrodes. In certain examples, the electrodes 45 can have lengths that extend along the axis 453 and can be circumferentially spaced with respect to one another about the axis 453. In certain examples, the substrate 452 can be plastic and the electrodes 455 can be integrated (e.g., molded in, embedded in, etc.) the plastic. In certain examples, the substrate 452 can be flexible such as a flexible circuit board and can be moved to a rolled configuration about the axis 453 to allow for insertion in a drain line component. In certain examples, the substrate 452 can be configured for insertion in a drain line component (e.g., a hose, pipe, tube, flow-through housing, etc.). In certain examples, the substrate 452 can have a self-supporting shape (e.g., a molded plastic shape) that can hold the electrodes in a desired configuration (e.g., a circumferentially spaced configuration). In certain examples, the substrate 452 can itself form a drain line component (e.g., a wall of a hose, pipe, tube, flow-through housing) with the electrodes integrated with the drain line component and secured within the drain line component along a flow passage of the drain line component. In certain examples, the drain line component can have an inner cross-dimension (e.g., an inner diameter) less than or equal to 1.5 inches or less than or equal to 1 inch or less than or equal to 0.75 inches which can correspond to a cross-dimension of a flow passage defined by the drain line component.

FIG. 32 depicts another electrode configuration 460 for generating biocide in a drain line such as the drain line from a condensate tray for collecting condensate from an evaporator coil. The electrode configuration 460 includes a substrate 462 defining an axis 463 adapted to run parallel to a direction of water flow through the drain line in which the electrode configuration is located. The substrate 462 can have a dielectric construction and can support a plurality of electrodes 465 (e.g., positive and negative electrodes with at least one or more electrodes being a bio-inhibiting conductor). In certain examples, the electrodes 465 can have lengths that extend along the axis 463 and can be circumferentially spaced with respect to one another about the axis 463. In one example, the electrodes 465 can be supported at a radially outwardly facing surface 467 of the substrate 462. In certain examples, the substrate 462 can be plastic and the electrodes 465 can be integrated in (e.g., molded in, embedded in, etc.) the plastic. In certain examples, the substrate 462 can be configured for insertion in a drain line component (e.g., a hose, pipe, tube, flow-through housing, etc.). In certain examples, the substrate 462 can have a self-supporting shape than can hold the electrodes in a desired configuration (e.g., a circumferentially spaced configuration). In certain examples, the substrate 462 can itself form a drain line component (e.g., a wall of a hose, pipe, tube, flow-through housing). The substrate 462 can include a cylindrical sleeve 469 forming an outer portion of the substrate 462 and an inner portion 473 of the substrate 462 can have a hub 475 at which the electrodes 465 are supported and legs 471 that project radially outwardly from the hub 475 and attach to an inside of the cylindrical sleeve 469. The legs 471 can unitarily connect with the cylindrical sleeve or otherwise connect with the cylindrical sleeve 469. In certain examples, the cylindrical sleeve 469 is configured to be inserted in a drain line component such as a flow-through housing, hose, pipe, or tube (e.g., a drain line component having an inner diameter less than or equal to 1.5 inches or less than or equal to 1 inch or less than or equal to 0.75 inches). In certain examples, the cylindrical sleeve 469 is itself a wall of a drain line component such as a flow-through housing, hose, pipe, or tube such that the inner portion 473 is integrated with (e.g., unitary with or otherwise connected to) the interior of the drain line component and the inner surface of the cylindrical sleeve 469 defines an inner diameter of the drain line component. In certain examples, the cylindrical sleeve 469 can be eliminated, and the inner portion 473 can be configured to be inserted into a drain line component such as a flow-through housing, hose, pipe, or tube with the legs 471 centering or otherwise positioning the inner portion 473 within the drain line component.

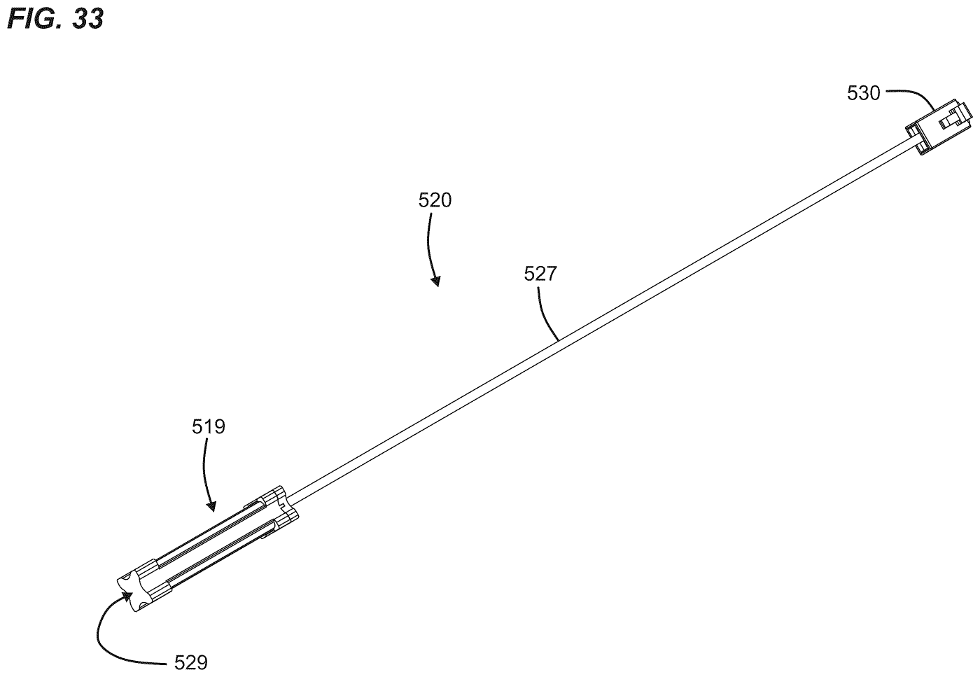

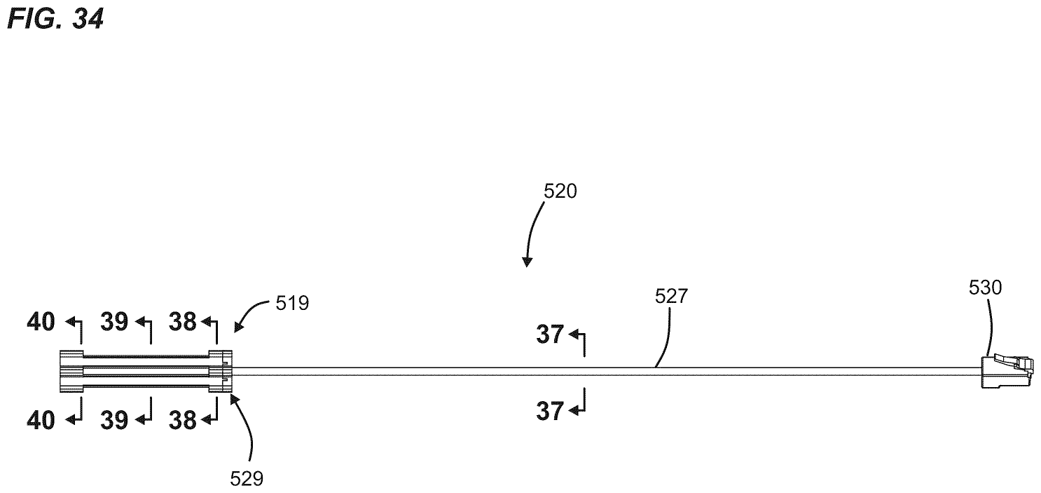

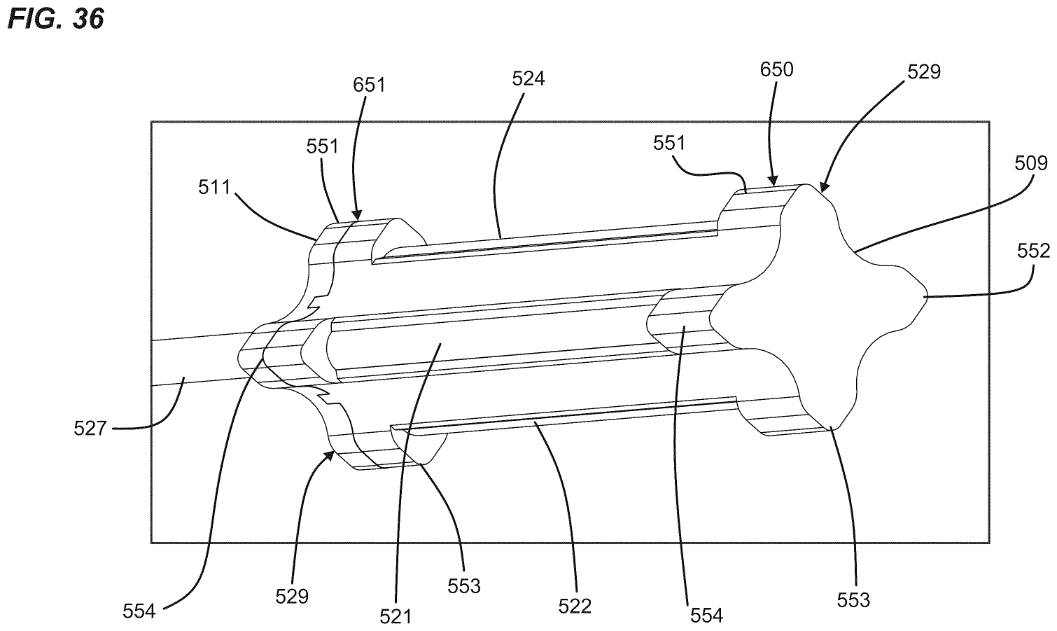

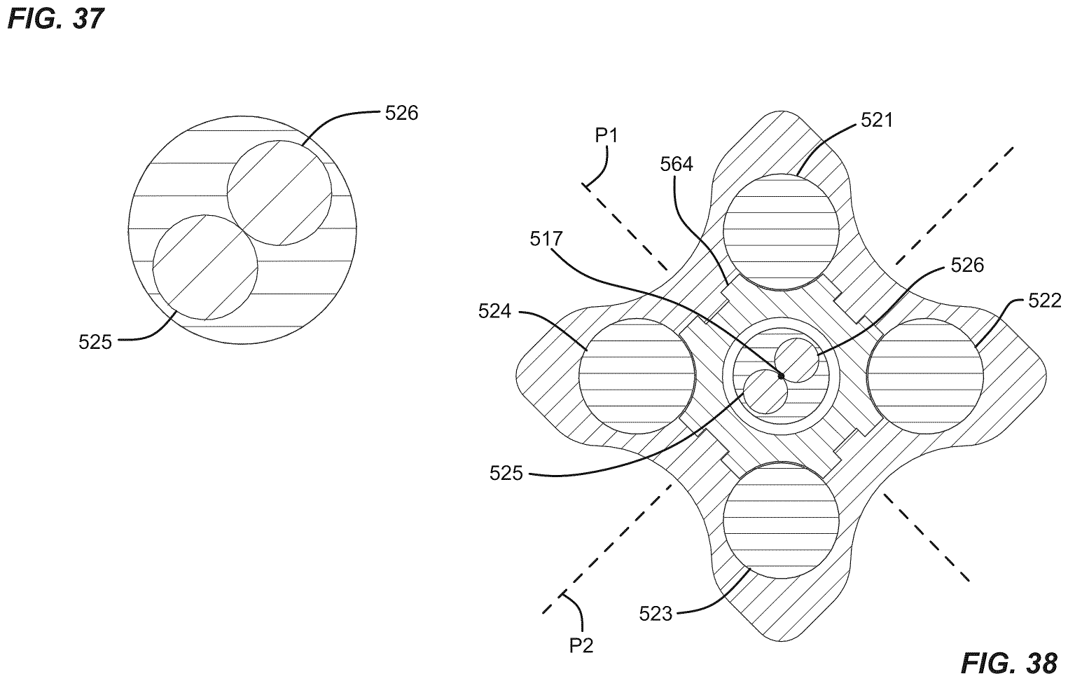

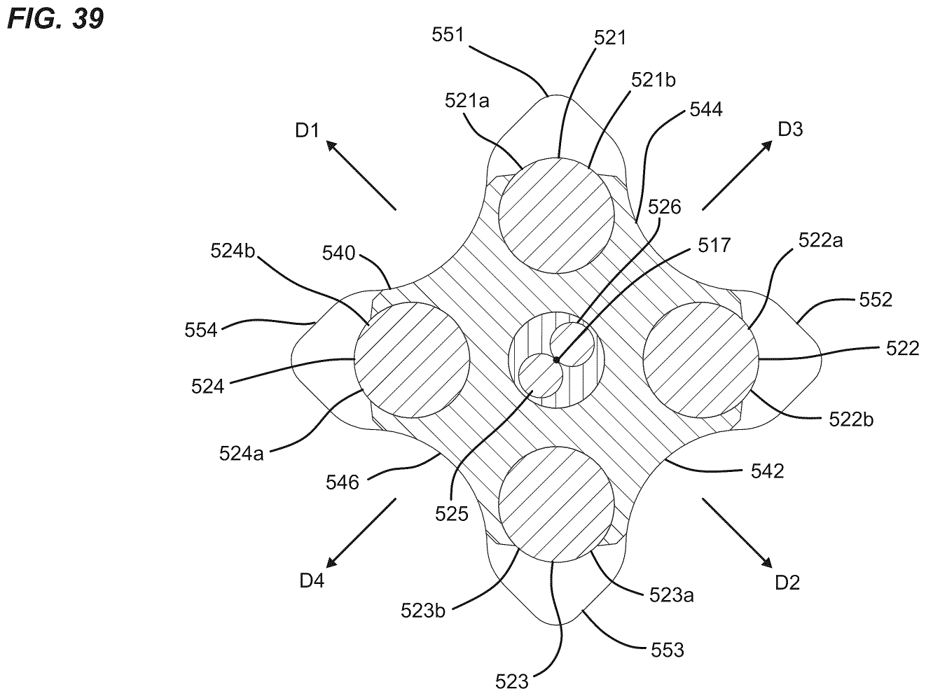

FIGS. 33-41 depict another electrode device 520 (e.g., a biocide-generating device) in accordance with the principles of the present disclosure for generating biocide in water within a condensate tray such as the condensate trays of FIGS. 1-3 or within a drain component. The electrode device can be used as the biocide generating device in the system of FIG. 27. The electrode device 520 includes an electrode arrangement 519 including a support structure 529 (e.g., a dielectric support structure). The electrode arrangement 519 also includes first, second, third and fourth electrodes 521-524 (see FIGS. 38 and 39) supported by the support structure 529. In one example, each of the four electrodes 521-524 includes a bio-inhibiting conductor. For example, the first, second, third and fourth electrodes 521-524 can each include a composition including a bio-inhibiting material such as copper. In the depicted example, the first, second, third and fourth electrodes 521-524 each has an elongate shape and the electrodes 521-524 are retained in spaced-apart, parallel relation with respect to each other by the support structure 529. In the depicted example, the electrodes 521-524 extend along a central longitudinal axis 517 of the electrode arrangement 519. In the depicted example, the first, second, third and fourth electrodes 521-524 are arranged in a rectangular configurations (e.g., a square configuration) with the first, second, third and fourth electrodes 521-524 being located at respective corners of the rectangular configuration. The first and third electrodes 521, 523 are diagonally positioned with respect to each other and the second and fourth electrodes 522, 524 are diagonally position with respect to one another. In one example, the electrode device 520 includes first and second wires 525, 526 (e.g., corresponding to wires 330 of the system of FIG. 27). The electrical wires 525, 526 electrically connect to an electrical power source and are routed such that the electrical power source can be used to drive electrical current across the electrode arrangement 519. The electrical power source can be controlled by or integrated as part of an electronic controller (e.g., of the type described elsewhere herein with respect to any of the other disclosed embodiments) that controls operation of the electrode device 520. The electrical wires 525, 526 can be integrated within an electrical cord 527 having a first and terminating at an electrical connector 530 (e.g., an electrical plug) and a second and routed into the electrode arrangement 519. The cord 527 can include a jacket surrounding the wires 525, 526. The wires 525, 526 can respectively connect to two of the contacts (e.g., the first two contact in the depicted row of contacts) of the connector 530 and the other contacts can be unused.

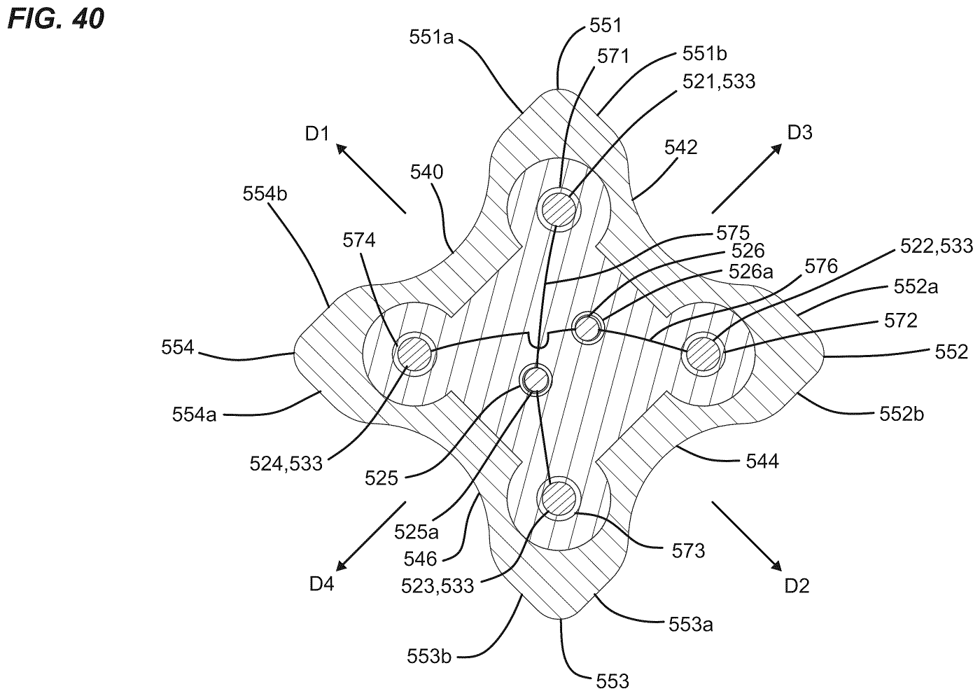

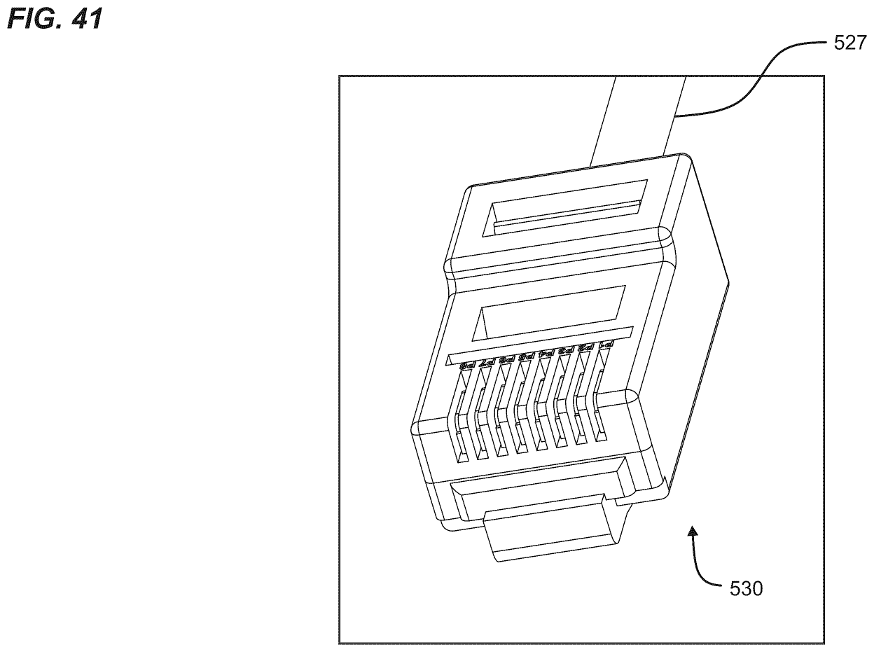

Within the support structure 529, the electrical wires 525, 526 can each electrically connect to selected ones of the electrodes 521-524. In one example, a circuit board 532 (see FIG. 40) can be incorporated within the support structure 529 for electrically connecting the electrical wires 525, 526 to the electrodes 521-524. In the depicted example, the first electrical wire 525 is electrically connected to the first electrode 521 and the third electrode 523; and the second electrical wire 526 is electrically connected to the second electrode 522 and the fourth electrode 524. In the depicted example, the electrodes 521-524 can have end portions 533 with reduced cross-sectional areas that are electrically connected to (e.g., fit within and are soldered to) respective first, second, third and fourth electrically conductive pads 571, 572, 573, 574 at corners of the circuit board 532. The first and second wires 525, 526 respectively electrically connect to (e.g., fit within and are soldered to) first and second electrically conductive pads 525a, 526a that are centrally located within the circuit board 532. The circuit board 532 includes a first electrically conductive layer (shown schematically by line 575) that electrically connects the first conductive pad 525a to the first and third electrodes 521, 523 and a second electrically conductive layer that electrically connects the second and fourth electrodes 522, 524 to the second conductive pad 526a. The circuit board can include a dielectric layer that separates the first and second electrically conductive layers.

In the depicted example, the electrode arrangement 519 is wired such that at a given time during operation of the electrode arrangement 519 the first and third electrodes 521, 523 have an opposite electrical charge as compared to the second and fourth electrodes 522, 524. The electrode arrangement 519 can be operated in two different polarity states and can shift between the polarity states. In the first polarity state, the first and third electrodes 521, 523 are wired as anodes and the second and fourth electrodes 522, 524 are wired as cathodes. In the second polarity state, the first and third electrodes 521, 523 are wired as cathodes and the second and fourth electrodes 522, 524 are wired as anodes. As described elsewhere herein, the electronic controller can be used to periodically shift the electrode device back-and-forth between the first and second polarity states at the electrode arrangement is operated over time.

Referring to FIG. 39, the electrode arrangement 519 includes a first side 540 that faces in a first direction D1, a second side 542 that faces in a second direction D2, a third side 544 that faces in a third direction D3 and a fourth side 546 that faces in a fourth direction D4. The first and second sides 540, 542 are positioned opposite from one another and the third and fourth sides 544, 546 are positioned opposite from one another. The first and second sides 540, 542 extend between the third and fourth sides 544, 546. The third and fourth sides 544, 546 extend between the first and second sides 540, 542. The first direction D1 is opposite from the second direction D2 and the third direction D3 is opposite from the fourth direction D4. The third and fourth directions D3, D4 are transversely oriented relative to the first and second directions D1, D2. The first electrode 521 is located at a transition between the first side 540 and the third side 544. The second electrode 522 is located at a transition between the third side 544 and the second side 542. The third electrode 523 is located at a transition between the second side 542 and the fourth side 546. The fourth electrode 524 is located at a transition between the fourth side 546 and the first side 540. Each of the sides 540, 542, 544 and 546 has a construction configured to inhibit short-circuiting of the electrodes as described with respect to the electrode device 120. Each of the sides 540,542, 544 and 546 has a construction configured to prevent water damming by minimizing the obstruction of water flow beneath the electrode arrangement (e.g., flow is permitted beneath the device in multiple perpendicular orientations/directions).

Referring still to FIG. 39, the first electrode 521 includes a first water contact portion 521a that faces at least partially in the first direction D1 and a second water contact portion 521b that faces at least partially in the third direction D3. The second electrode 522 includes a first water contact portion 522a that faces at least partially in the third direction D3 and a second water contact portion 522b that faces at least partially in the second direction D2. The third electrode 523 includes a first water contact portion 523a that faces at least partially in the second direction D2 and a second water contact portion 523b that faces at least partially in the fourth direction D4. The fourth electrode 524 includes a first water contact portion 524a that faces at least partially in the fourth direction D4 and a second water contact portion 524b that faces at least partially in the first direction D1.

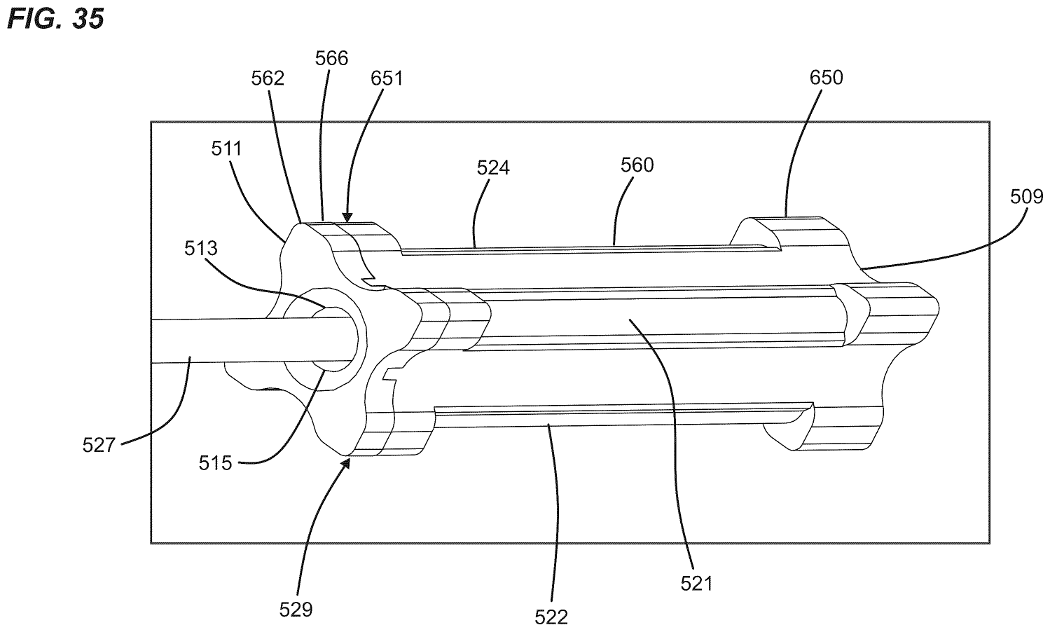

The support structure 529 is elongate along the central longitudinal axis 517 and extends between first and second ends 509, 511. The cord 527 enters the support structure 529 at an entry location 515 at the second end 511. The entry location 515 is defined along the central longitudinal axis 517 and can be co-axial with the central longitudinal axis 517. The electrode arrangement 519 can be symmetric about first and second perpendicular reference planes P1, P2 (see FIG. 38) that intersect at the central longitudinal axis 517 and both include the longitudinal axis 517. The electrode arrangement is symmetric about the central longitudinal axis 517. At the entry location 515, the support structure can define a cord opening 513 having a tapered configuration that enlarges as the cord opening 513 extends in an outward direction (see FIG. 35). In a preferred example, the cord opening 513 has a funnel shape such as a truncated cone shape. The tapered configuration of the opening 513 helps ensure one of the sides of the electrode arrangement 519 can lay flat on a support structure such as the bottom of a tray without interference from the cord 527. In a preferred example, the cord 527 is also sufficiently flexible to not interfere with the ability of the electrode arrangement 519 to lay flat on a support surface.

The support structure 529 includes flanges 650, 651 respectively positioned at the opposite first and second ends 509, 511 of the electrode arrangement 519. The circuit board 532 is positioned at the flange 650 adjacent the first end 509. Each of the flanges 650, 651 includes a first support projection 551, a second support projection 552, a third support projection 553, and a fourth support projection 554. The support projections can also be referred to as feet, legs, supports or like terms. The support projections 551-554 define base structures at each of the sides 540, 542, 544 and 546 of the electrode arrangement 519. The electrode arrangement 519 is configured such that in use any one of the base structures (i.e., any one of the four sides 540, 542, 544, 546) can contact a bottom of the condensate tray or drain component when the electrode device is installed within the condensate tray or drain component. In use, the side 540, 542, 544 or 546 of the electrode arrangement 519 being used as a base structure defines a base reference plane that coincides with the bottom of the condensate tray or drain component when the electrode arrangement 510 is installed in the condensate tray or drain component. An open vertical space is defined between the base reference plane and the electrode water contact portions corresponding to the side functioning as the base. This allows water in the condensate tray or drain component to flow directly beneath the corresponding water contact portions. By allowing any one of the multiple sides of the electrode arrangement to be used as a base, the electrode arrangement is prevented from being improperly installed (e.g., installed up-side-down such that water contact surfaces are not positioned to contact water in the tray or other component of a condensate collection and drain system). In the depicted example, each of the sides 540, 542, 544 and 546 has the same configuration and each is configured to allow flow beneath the electrode arrangement in multiple transverse orientation to prevent water damming.

The first support projection 551 of each flange 650, 651 is located at a transition between the first side 540 and the third side 544 and includes a first surface 551a that faces at least partially in the first direction D1 and a second surface 551b that faces at least partially in the third direction D3. The second support projection 552 of each flange 650, 651 is located at a transition between the third side 544 and the second side 542 and includes a first surface 552a that faces at least partially in the third direction D3 and a second surface 552b that faces at least partially in the second direction D2. The third support projection 553 of each flange 650, 651 is located at a transition between the second side 542 and the fourth side 546 and includes a first surface 553a that faces at least partially in the second direction D2 and a second surface 553b that faces at least partially in the fourth direction D4. The fourth support projection 554 of each flange 650, 651 is located at a transition between the fourth side 546 and the first side 540 and includes a first surface 554a that faces at least partially in the fourth direction D4 and a second surface 554b that faces at least partially in the first direction D1.

When the first side 540 of the electrode arrangement 519 is used as the base, the first direction D1 faces downwardly toward the tray or other component, the surfaces 551a, 554b of the first and fourth projections 551, 554 engage the tray or other component and the water contact portions 521a, 524b of the first and fourth electrodes 521, 524 face downwardly toward the tray or other component and are spaced from the tray or other component by the first and fourth projections 551, 554. When the second side 542 of the electrode arrangement 519 is used as the base, the second direction D2 faces downwardly toward the tray or other component, the surfaces 552b, 553a of the second and third projections 552, 553 engage the tray or other component and the water contact portions 522b, 523a of the second and third electrodes 522, 523 faced downwardly toward the tray or other component and are spaced from the tray or other component by the second and third projections 522, 523. When the third side 544 of the electrode arrangement 519 is used as the base, the third direction D3 faces downwardly toward the tray or other component, the surfaces 551b, 552a of the first and second projections 551, 552 engage the tray or other component and the water contact portions 521b, 522a of the first and second electrodes 521, 522 face downwardly toward the tray or other component and are spaced from the tray or other component by the first and second projections 551, 552. When the fourth side 546 of the electrode arrangement 519 is used as the base, the fourth direction D4 faces downwardly toward the tray or other component, the surfaces 554a, 553b of the third and fourth projections 553, 554 engage the tray or other component and the water contact portions 523b, 524b of the third and fourth electrodes 523, 524 face downwardly from the tray or other component and are spaced from the tray or other component by the third and fourth projections 553, 554.

The support structure 529 preferably has a dielectric (e.g., plastic) construction and is configured to maintain separation (e.g., electrically and physically) between the electrodes 521-524. The support structure 529 has a construction including a main body 560 and an end plate 562. The end plate 560 can include a core 564 (see FIG. 38) and a flange portion 566 (see FIG. 35) that projects outwardly from the core 564. The flange portion 566 can be configured define at least a portion of the flange 651. The cord opening 513 can be defined through the core 564. During manufacture, the electrodes 521-524 can be preassembled with the end plate 560 and the circuit board 532. Ends of the electrodes 521-524 can be soldered to the corner pads of the circuit board 532 and the wires 525, 526 can be routed through the cord opening and along the longitudinal axis 517 to the circuit board 532 where the wires are soldered to the central pads of the circuit board 532. The circuit board 532 and the end plate 560 function to retain the electrodes 521-24 in the generally rectangular configuration. The assembly including the circuit board 532, the end plate 560, the electrodes 521-524 and the wires 525, 526 is then inserted into a mold and the main body 560 of the support structure 529 is formed by an injection molding process in which dielectric material is injected into the mold to define the main body 560.

The electrodes 521-524 are electrically connected by the wires 525, 526 to an electrical power source (e.g., controlled by or part of controller 329 of FIG. 27). As indicated previously, the electrode arrangement 519 is wired with respect to the electrical power source to provide an electrical circuit configures such that during use of the device the first and third electrodes 521, 523 are provided with a first charge and the second and fourth electrodes 522, 524 are provided with a second charge which is opposite from the first charge. The electrical circuit can be configured such that the polarity of the circuit can switch between a first state in which the first and second electrodes 521, 523 are provided with a positive charge (e.g., associated with the positive terminal of the electrical power source) and the second and fourth electrodes 522, 524 are provided with a negative charge (e.g., associated with ground/reference ground), and a second state in which the first and second electrodes 521, 523 are provided with the negative charge and the second and fourth electrodes 522, 524 provided with the positive charge. The controller (e.g., controller 329) can be configured to measure/monitor an electrical current flowing between the electrodes corresponding to the side of the electrode arrangement 519 functioning as a base. If the sensed electrical current exceeds a predetermined level (which would be indicative of an abnormally high concentration of biocide in the water of the tray or other component), the controller can terminate providing electrical power to the electrode arrangement 519 and issue an alert.

In an alternative example, rather than two wires, four wires could be used with each of the wires being electrically connected to one of the electrodes 521-524. Similar to the two-wire embodiment, the electrical power circuit for the four wire embodiment pairs together the first and third electrodes 521, 523 (e.g., first diagonal electrodes) to provide the first and third electrodes 521, 523 with the same first electrical charge and pairs together the second and fourth electrodes 522, 524 (e.g., second diagonal electrodes) to provide the second and fourth electrodes 522, 524 with the same second electrical charge opposite from the first electrical charge. In this example, the controller can sense and differential the existence of electrical current flowing between any two of the electrodes. If electrical current flow is detected between more than two of the electrodes (as would occur when the depth of the water in the tray or other component is deep enough to contact all four of the electrodes at once), the controller can terminate electrical power to the electrode arrangement and generate an alert indicating that the tray or other component is plugged.

The electrode arrangement 519 can be electrically powered to generate biocide by an electrical power source (e.g., integrated with or controlled by the controller 329) configured to drive electrical current between the two of the electrodes 521-524 that in use are adapted to contact water within the structure (e.g., a tray/pan) in which bio-growth is intended to be inhibited. Through an electrical circuit, the electrical power source can be configured to drive electrical current in the form of pulsed direct current (DC) across a set of electrodes of the electrode arrangement 519 to cause biocide (e.g., copper ions) to move into the water being treated. The electrical circuit can extend from a positive terminal of the electrical power source to one of the electrodes at the side of the electrode arrangement 519 functioning as the base, and from the other one of the electrodes at the side of the electrode arrangement 519 functioning as the base to ground/reference ground. Water being treated by the device provides an electrical connection between the two electrodes to close the circuit. The pulsed direct current driven by the electrical power source can have a frequency of at least 4 kilohertz, or at least 5 kilohertz, or in the range of 5-20 kilohertz, or in the range of 5-10 kilohertz and the electrical power source can use a voltage of at least 10 volts, or at least 12 volts, or in the range of 12-16 volts, or in the range of 13-15 volts, or at least 14 volts to drive the pulsed current. The power source of the type described above can be used with any electrode arrangement in accordance with the principles of the present disclosure and has been found to generate sufficient biocide to effectively treat water in a component of a condensate collection and drain system without generating levels of by-product that can cause short-circuiting of the electrode arrangement. The pulsed direct current can be applied during periods in which the electrodes are in a first polarity state and during periods in which the electrodes are in a second polarity state opposite form the first polarity state.

Electrodes in accordance with the principles of the present disclosure receive electrical current from a dedicated or external power supply, i.e., an electrical current source. Electrically connected (e.g., via wires, traces, or other conductors) to the current source are the two electrodes-an anode and a cathode. It should be appreciated that the first and second electrodes can functionally switch roles (i.e., such that which of the two electrodes functions as the anode and which of the electrodes functions as the cathode switch depending on the direction of current flow (i.e., the polarity of the electrodes).

With respect to embodiments of the present disclosure, one or both electrodes can include(s) a bio-inhibiting substance, i.e., a bio-inhibiting conductor or chemical (BIC), such as copper, zinc, aluminum, silver, or another conductor or chemical that is known now or in the future to have bio-inhibiting properties and that is released from the electrode by electrolysis. The BIC is in a molecular or elemental form on the electrode(s) that enables the BIC to be released into an electrolyte when an electrical current is made to flow through/between the electrodes. The BIC can be integrated with the electrode or coated on the surface of the electrode. In some examples, one or both electrodes include a conducting material that is resistant to oxidation, e.g., stainless steel, carbon, or another suitable conductor.

With respect to embodiments of the present disclosure, a first one of the electrodes can include copper metal (Cu), and a second one of the electrodes can include stainless steel or titanium. When electrical current is caused to flow through the electrodes by a current source in the presence of an electrolyte (e.g., water collected in the tray that contacts both electrodes forming a conductive bridge therebetween), copper ions (Cu⁺⁺) are released into the electrolyte from the first electrode until the copper metal of the electrode first is used up. The copper ions present in the electrolyte (i.e., the collected water) inhibit the growth of biological organisms in the tray and drain.

As used herein, terms such as “conductivity,” “conductively,” and related terms, refer to the movement of ions in aqueous solutions, i.e., ionic conduction/conductivity.

According to certain aspects of the present disclosure, a bio-inhibition system for controlling the buildup of biological material in an air treatment system which includes one or more condensate drain lines includes a current source connected to a pair of spaced apart electrodes, wherein one or more of the electrodes includes a bio-inhibiting ion or chemical inhibitor, and wherein both of the electrodes are positioned to be exposed to liquid present (e.g., condensate in air conditioning and dehumidifying systems) in a liquid collection subsystem of the air treatment system. The liquid present acts as an electrolyte that electrically bridges the electrodes to each other, the current source providing the driving force needed to perform migration of ions or chemical inhibitor from the electrodes at a fixed rate, causing the first electrode to release bio-inhibiting ions/chemicals into the liquid. The bio-inhibiting ions then enter the liquid and inhibit the growth of certain organisms within the liquid media. In certain examples, the electrical current from the current source is driven by a voltage in the range of 8-15 volts, or greater than 8 volts.

An electrical current from a current source is connected to the electrodes and the liquid present in the condensate tray bridges the first and second electrodes as ions begin to enter the liquid. In some examples, either electrode can be connected to the positive or negative side of the current source and the direction of current flow can be reversed periodically to extend the life of the device. It should be appreciated, therefore, that in some examples, both electrodes may contain a bio-inhibiting material, and the electrode that releases the bio-inhibiting material at any given time depends on the direction of current flow.

Thus, in at least some examples, the bio-inhibiting system of the present disclosure is adapted to inject bio-inhibiting ions and chemicals when the first and second electrodes are at least partially in contact with liquid contained in the liquid collection subsystem and the current source releases ions at a predetermined rate which is proportional to the magnitude of the current.

In some examples, the bio-inhibiting electrode is made of metal or other conductive material metal (e.g., a mixture containing carbon, or a polymer and a metal salt). In some examples, the bio-inhibiting conductor comprises one or more of copper, aluminum, zinc, silver or another electrical conductor such as carbon, or conductive polymer, mixed with a bio-inhibiting material, known now or in the future to have bio-inhibiting properties.

It will be appreciated that the bi-inhibiting ions are released into the condensate from the anode side (e.g., positive side) of the circuit rather than the cathode side; thus, the anode electrode is sacrificial. Thus, by incorporating the biocide material into both the first and second electrodes and periodically reversing the polarity of the electrodes (e.g., reversing the charges of the electrodes), the life of the electrode device can be extended since both electrodes can be sacrificed (e.g., alternatingly) over time as compared to just one being sacrificed.

Each electrode can include a plurality of electrode members that cooperate to define a surface area of the electrode. For example, an electrode device in accordance with the principles of the present disclosure can include a first electrode (e.g., an anode) including a plurality of first electrode members having the same charge (e.g., a positive charge) and a second electrode (e.g., a cathode) including a plurality of electrode members having the same charge (e.g., a negative charge).

In some examples, the voltage and/or current of the current source is measured when the electrode is activated. The voltage and current can be used to determine the presence and/or conductivity of the liquid in the liquid collection system. Changes in the conductivity of the liquid can be indicative of changes in the ion concentration present in the liquid. This measurement can be used by the controller to adjust the current source power delivery to increase or decrease ion concentration. Current is typically DC for creating ions but can be driven in an AC configuration to measure conductivity without creating ions. Conductivity can be used to determine when liquid is present. For example, change in conductivity can be used with a level sensor (e.g., sensor 364) to determine when the tray fills to a level indicative of a blockage. Alternatively, an increase in conductivity as sensed across probes 362, 363 or across the electrodes 324, 326 (e.g., by driving AC current across the electrodes while the DC voltage is terminated for conductivity monitoring without ion production) can be used to identify low-flow or no-flow conditions indicative of a drain clog. In other examples, conductivity across the electrodes 324, 326 can be sensed simultaneously with DC voltage being applied across the electrodes 324, 326 to generate electrical current between the electrodes 324, 326 for causing biocide ion release wherein the level of electrical current is indicative of conductivity (e.g., the level of electrical current that flows between the electrodes at a known applied DC voltage is used as a basis for sensing/estimating/monitoring conductivity). In certain examples, the system can terminate/stop/disconnect the applied DC voltage if the conductivity rises to a predetermined threshold level. The conductivity threshold level can be selected to be indicative of a low-flow or non-flow condition indicative of a drain clog or can be indicative of another type of system error or failure. In certain examples, the electrical current level caused by a DC voltage applied between the electrodes is measured real-time with the electrolysis driven by a DC voltage.

The various examples described above are provided by way of illustration only and should not be construed to limit the scope of the present disclosure. Those skilled in the art will readily recognize various modifications and changes that may be made with respect to the examples illustrated and described herein without departing from the true spirit and scope of the present disclosure.

1-84. (canceled)

85. An electrode device for generating biocide in water within a condensate collection and drain system, the electrode device comprising:
a support structure;
first and second electrodes retained in spaced apart relation relative to each other by the support structure, at least the first electrode being a bio-inhibiting conductor, the first and second electrodes each having an exposed water contact surface with more than 50 percent of each exposed water contact surface facing in a first direction; and
wherein the support structure is configured to block all linear vectors from extending directly between the first and second electrodes.

86. The electrode device of claim 85, wherein at least 60, 70, 80 or 90 percent of each exposed water contact surface faces at least partially in the first direction.

87. The electrode device of claim 85, wherein the first direction is a downward direction.

88. The electrode device of any of claim 85, wherein the support structure and/or the first and second electrodes define an open region for allowing water flowing along the condensate collection and drain system to flow under and/or through the electrode device.

89. The electrode device of any of claim 85, wherein the first and second electrodes are fully covered by the support structure at one side of the electrode device.

90. The electrode device of claim 89, wherein the one side is a top side and wherein the exposed water contact surfaces are exposed at a bottom side of the electrode device.

91. The electrode device of any of claim 85, wherein top portions of the first and second electrodes are fully covered by the support structure such that in use deposition of conductive material from above cannot create an electrical short between the first and second electrodes.

92. The electrode device of any of claim 85, wherein the electrode support structure is configured to promote sloughing off in an outside direction of buoyant conductive material in the water being treated by the electrode device as the buoyant material rises from beneath the electrode device.

93. The electrode device of any of claim 85, wherein the first electrode is at a side of the electrode device, and wherein the side of the electrode device is angled to promote sloughing off in an outside direction of buoyant conductive material in the water being treated by the electrode device as the buoyant material rises from beneath the electrode device.

94. The electrode device of claim 93, wherein the side defines an angle in the range of 30-60 degrees relative to the base reference plane.

95. The electrode device of claim 94, wherein the first electrode is positioned between projections of the electrode support structure, and the angle of the side is defined by a reference line that extends across outer extents of the projections.

96. An electrode device for generating biocide in water within a condensate collection and drain system, the electrode device comprising:
an electrode support structure defining a base reference plane adapted to be positioned at a support surface of a component of the condensate collection and drain system when the electrode device is supported within the component;
first and second electrodes supported by the electrode support structure at locations spaced from the base reference plane, at least the first electrode being a bio-inhibiting conductor;
an electric circuit including an electrical power source and the first and second electrodes, the electrical power source being configured to drive electrical current in the form of pulsed direct current across the first and second electrodes to cause biocide to move into the water being treated, the pulsed direct current driven by the electrical power source having a frequency of at least 4 kilohertz and being driven by a voltage of at least 10 volts.

97. The electrode device of claim 96, wherein the pulsed direct current driven by the electrical power source has a frequency of in the range of 5-20 kilohertz and is driven by a voltage in the range of 12-16 volts.

98. The electrode device of claim 96, wherein the pulsed direct current driven by the electrical power source has a frequency of in the range of 5-10 kilohertz and is driven by a voltage in the range of 13-15 volts.

99. An electrode device for generating biocide in water within a condensate collection and drain system, the electrode device comprising:
an electrode support structure defining a first side and an opposite second side, the electrode support structure also defining a third side and an opposite fourth side, the first and second sides being configured to extend between the third and fourth sides and the third and fourth sides being configured to extend between the first and second sides;
first, second, third and fourth electrodes supported by the electrode support structure, the first electrode being positioned at a transition between the first side and the third side, the second electrode being positioned at a transition between the third side and the second side, the third electrode being positioned at a transition between the second side and the fourth side, and the fourth electrode being positioned at a transition between the fourth side and the first side; and
an electrical circuit including an electrical power source and the first, second, third and fourth electrodes, the electrical circuit being configured such that in use of the electrode device the first and third electrodes have a first charge and the second and fourth electrodes have an opposite second charge.

100. The electrode device of claim 99, wherein the first, second, third and fourth conductors each has a construction including a bio-inhibiting conductor.

101. The electrode device of claim 99, wherein the wherein the first, second, third and fourth conductors are arranged in a rectangular configuration.

102. The electrode device of claim 101, wherein the rectangular configuration is a square configuration.

103. The electrode device of claim 99, wherein the electrode support structure has an elongate construction that extends along a central longitudinal axis, and wherein the first, second, third, and fourth electrode each has a length that extends along the central longitudinal axis.

104. The electrode device of claim 99, wherein the first side faces in a first direction, wherein the second side faces in a second direction opposite from the first direction, wherein the third side faces in a third direction transverse with respect to the first and second directions, and wherein the fourth side faces in a fourth direction opposite from the third direction.

105. The electrode device of claim 104, wherein the first electrode includes a first water contact portion that faces at least partially in the first direction, and a second eater contact portion that faces at least partially in the third direction, wherein the second electrode includes a first water contact portion that faces at least partially in the third direction and a second water contact portion that faces at least partially in the second direction, wherein the third electrode includes a first water contact portion that faces at least partially in the second direction and a second water contact portion that faces at least partially in the fourth direction, and wherein the fourth electrode has a first water contact portion that faces at least partially in the fourth direction and a second water contact portion that faces at least partially in the first direction.

106. The electrode device of claim 105, wherein the electrode support structure has an elongate construction that extends along a central longitudinal axis between a first end and a second end, and wherein the first, second, third, and fourth electrode each has a length that extends along the central longitudinal axis.

107. The electrode device of claim 106, further comprising an electrical cord that enters the electrode support structure through an opening defined through the second end of the electrode support structure, the opening being co-axial with the central longitudinal axis and having a tapered configuration that enlarges as the opening extends outwardly.

108. The electrode device of claim 107, wherein the electrode support device includes flanges adjacent each of the first and second ends, wherein each of the flanges includes a first projection at the transition between the first side and the third side, a second projection at the transition between the third side and the second side, a third projection at the transition between the second side and the fourth side, and a fourth projection at the transition between the fourth side and the first side.

109. (canceled)
